(19) United States
(12) Patent Application Publication
(10) Pub. No.: US 2026/0111475 A1
(43) Pub. Date: Apr. 23, 2026

(54) IDEA SUBMISSION AND ACCESS MANAGEMENT SYSTEM

(71) Applicant: IP Copilot, Inc., Columbia, TN (US)

(72) Inventors: Austin Grant Walters, Columbia, TN (US); Jeremy Edward Goodsitt, Champaign, IL (US); Grant Mitchell Eden, San Francisco, CA (US)

(21) Appl. No.: 19/337,851

(22) Filed: Sep. 23, 2025

Related U.S. Application Data
(60) Provisional application No. 63/697,795, filed on Sep. 23, 2024.

(51) Int. Cl. G06F 16/34; G06F 21/62; G06F 40/197

(52) U.S. Cl. CPC G06F 16/345; G06F 21/62; G06F 40/197

(57) ABSTRACT

Systems and methods for constructing an access-controlled idea graph from heterogeneous inputs. The system ingests user submissions and/or parses enterprise documents to extract candidate ideas, computes similarity between ideas, and links or merges related ideas to form a versioned evolution graph. For any querying user, the system evaluates access privileges against source-document permissions to derive a user-specific permutation of the idea graph. In response to a query, the system synthesizes a comprehensive disclosure from the accessible subgraph and outputs a structured report, optionally using generative AI to produce summaries, problem/solution statements, prior-art indications, and predicted classifications. Portfolio tools permit one-click generation of disclosure forms from selected versions and provide analytics such as uniqueness scores. Training and inference components implement the extraction, linking, merging, and synthesis workflows. The architecture supports enterprise integration, version control across permutations of an idea and role-based visibility (e.g., portfolio manager able to view merged, organization-wide version).

### FIELD OF DISCLOSURE

The present disclosure is generally related to computer-implemented knowledge management systems, and more specifically to techniques for extracting ideas from heterogeneous sources and building an access-controlled idea graphs with version tracking for synthesizing invention disclosures or other reports.

### BACKGROUND

The invention disclosure process is a formal procedure where inventors provide detailed information about their invention to an organization, such as a university or company. This process protects intellectual property rights by establishing a documented record of the invention. Additionally, it facilitates technology transfer by enabling organizations to evaluate the commercial potential of inventions and explore opportunities for licensing or further development. The process typically involves inventors preparing a comprehensive disclosure, including technical descriptions, drawings, and experimental data. They then submit this information using a standardized form provided by the receiving entity. The entity evaluates the invention's novelty, patentability, and market potential before making a decision on further action, such as filing a patent application or licensing the technology. Prompt and detailed invention disclosure is crucial for protecting intellectual property, ensuring compliance with regulations, and potentially leading to commercial success.

The invention disclosure process, while essential, is not without its challenges. One common issue is the complexity and time-consuming nature of preparing a comprehensive disclosure, which can deter inventors, particularly those with limited resources or experience. Moreover, there can be ambiguity in determining inventorship and ownership, especially in collaborative research settings, leading to potential disputes. The evaluation process itself can be lengthy and subjective, with variations in assessment criteria and decision-making across different organizations. Furthermore, concerns about confidentiality and potential conflicts of interest can arise, particularly when inventions involve sensitive information or competing commercial interests. These challenges underscore the need for streamlined procedures, clear guidelines, and effective communication between inventors and receiving entities to ensure a smooth and successful invention disclosure process.

### SUMMARY OF THE DISCLOSURE

In various embodiments, a system and a computer-implemented method can be described for managing submissions of ideas. This process involves the system receiving an idea submission from a user or another source. The system then identifies this idea as part of one or more other previously submitted ideas (or a new idea) by comparing it against existing data within its database. Once identified, the system stores associated data with the new submission and establishes relationships between this new submission and any related previous submissions in a designated data store. This method enables tracking of conceptual evolution and connections among various idea proposals over time.

Further, the system and method provide an innovative approach to managing intellectual property disclosures related to ideas. The process begins with the system receiving input that triggers the generation of a comprehensive disclosure form designed to encapsulate all pertinent details about an idea. Subsequently, the system identifies one or more submissions tied to this idea and utilizes their data as the foundation for populating the disclosure document. By integrating information from various sources within these submissions, the system ensures that each aspect of the idea is accurately represented in the final form. The resulting disclosure not only serves as a means of documentation but also acts as an authoritative reference that can be used to protect and communicate the essence of an innovative concept or project across different stakeholders and legal frameworks, thereby safeguarding the rights of inventors while fostering collaboration among contributors.

Embodiments may also include a system and method, including the multi-step process for managing and disseminating data related to an idea or concept within a system. Upon receiving a user's request to view associated data, the system first identifies the appropriate access level for that individual based on their role or status. It then evaluates each submission linked to the idea against both the user's access rights and access levels for submissions to ascertain which pieces of information are permissible for disclosure. Following this assessment, the system generates a tailored content package from the selected submissions using sophisticated data processing techniques, such as AI-driven generative models. Finally, this curated content is presented within a graphical user interface (GUI), transforming raw data into an interactive and visually engaging format that enhances user comprehension and facilitates informed decision-making. This method represents the integration of security protocols with advanced information technology to ensure both the protection of sensitive data and the provision of valuable insights in a manner conducive to professional environments where idea management is essential.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system 100 in accordance with embodiments discussed herein.

FIG. 2 illustrates an exemplary block diagram of a system architecture for constructing and serving an access-controlled idea graph, in accordance with one embodiment.

FIG. 3 illustrates a routine 300 in accordance with one embodiment.

FIG. 4A illustrates a data model for idea objects, source references, edges and permissions, in accordance with one embodiment.

FIG. 4B illustrates a flowchart of similarity computation and link-or-merge decisioning, in accordance with one embodiment.

FIG. 4C illustrates a versioned evolution graph with succession and equivalence edges, in accordance with one embodiment.

FIG. 5 illustrates an aspect of the subject matter in accordance with one embodiment.

FIG. 6 illustrates an aspect of the subject matter in accordance with one embodiment.

FIG. 7A illustrates an example graphical user interface display, in accordance with one embodiment.

FIG. 7B illustrates an example graphical user interface display, in accordance with one embodiment in accordance with one embodiment.

FIG. 8 illustrates an example graphical user interface display, in accordance with one embodiment.

FIG. 9 illustrates a system architecture comprising client devices, an inferencing device, and a data repository interconnected via one or more networks, in accordance with one embodiment.

FIG. 10 illustrates an apparatus 1000 in accordance with one embodiment.

FIG. 11 illustrates an artificial intelligence architecture 1100 in accordance with one embodiment.

FIG. 12 illustrates an artificial neural network 1200 in accordance with one embodiment.

FIG. 13 illustrates a computer-readable storage medium 1302 in accordance with one embodiment.

FIG. 14 illustrates a computing architecture 1400 in accordance with one embodiment.

FIG. 15 illustrates a communications architecture 1500 in accordance with one embodiment.

### DETAILED DESCRIPTION

Organizations generate large numbers of invention disclosures, email threads, design documents, code comments, and other materials that contain overlapping ideas. Conventional repositories lack (i) a persistent representation linking semantically related ideas across documents and time, (ii) a principled way to merge iterative versions of an idea while preserving provenance, and (iii) access-controlled, role-appropriate views in compliance with the permissions of the underlying sources. As a result, patent counsel and portfolio managers struggle to (a) detect near-duplicates, (b) trace the evolution of an idea, (c) assemble a comprehensive disclosure grounded in all permissible evidence, and (d) quantify how unique a proposed idea is within the organization.

Existing search systems largely return document lists, not structured idea graphs. Collaborative tools provide version control for documents but not for ideas independently of file boundaries. Vector search can surface similar passages, yet without a merge policy, users must reconcile overlaps by hand. Moreover, naïve aggregation often violates confidentiality by exposing content from sources a particular user may not have access to. There is a need for systems that (1) extract and normalize ideas, (2) link and merge them under explicit policies, (3) project the resulting global structure into user-specific permutations consistent with permissions, and (4) synthesize disclosures or reports from those permutations.

In one aspect, a system constructs an access-controlled idea graph from heterogeneous inputs. The system ingests user submissions and/or parses enterprise documents to extract candidate idea objects, computes similarity between ideas, and links or merges related ideas into a versioned evolution graph. For a querying principal, the system evaluates access privileges against source-document permissions to derive a user-specific permutation-a deterministic projection of the global graph restricted to content the principal may view. In response to a query or workflow trigger, a synthesis module traverses the accessible subgraph and generates a structured disclosure (e.g., patent specification sections) or other report.

Alternative embodiments include tag-assisted matching to reduce computational cost, and a uniqueness score assigned to ideas or clusters based on neighborhood density in an embedding space. Training and inference components implement the extraction, linking, merging, and synthesis workflows. Administrative roles (e.g., a portfolio manager) are enabled to view merged, organization-wide versions consistent with their permissions.

In embodiments, systems discussed herein enable multiple users to upload documents, and/or the system can automatically pull concepts in real-time through various methods, and our system discovers ideas. The system tracks the source of each idea. The described systems facilitate collaborative document management, allowing multiple users to upload and share files seamlessly based on privilege or access levels. Additionally, these systems incorporate advanced algorithms for real-time extraction of ideas or concepts from the uploaded documents. They employ techniques such as natural language processing (NLP) and machine learning to identify key themes, patterns, and insights that may not be immediately apparent to human users. Furthermore, the system maintains a comprehensive record of the origin of each identified idea by associating it with its corresponding document source. This feature helps in attributing credit accurately and enables efficient tracking of information flow among team members or stakeholders and limits access to those that have appropriate access levels. By integrating various data retrieval methods such as keyword extraction, semantic analysis, and contextual understanding, these systems ensure a robust mechanism for capturing valuable insights from diverse documents while maintaining a clear record of their origins. This approach enhances the overall productivity, knowledge sharing, and innovation within collaborative environments and enables automatic generation of invention disclosure forms.

In embodiments, the system incorporates a sophisticated version control mechanism for managing and tracking the evolution of ideas within its database. Whenever an idea is identified, it generates a reference or link that not only acknowledges its appearance but also associates it with the contributor's identity. This ensures proper attribution and traceability. As users contribute to these ideas, they can update them by adding new insights, refining existing concepts, or building upon previous iterations. Each updated version of an idea is tagged accordingly (e.g., X′, X″), allowing for easy identification and retrieval of the most up-to-date information on that specific topic. This hierarchical structure provides a clear understanding of how ideas have evolved over time, enabling users to access different versions based on their contributions or interests and access level. For example, USER A, who contributed X′, can see X′ and any variations they can access, while USER B, who contributed X″, can view X″ and any variations they can access. For example, in some instances, the system may prevent USER A from accessing to X″, and USER B from accessing X′ based on their assigned access levels. In another example, the USER A may be able to access X′ and X″, while USER B may only be able to access X″ based on their access level. Other users may have access to all of the idea data submitted for a particular idea, e.g., X, X′, X″. For example, the portfolio manager has full visibility of all versions, including the original idea (X), as well as its subsequent developments (X′, X″). By incorporating this version control system, users can collaborate efficiently and effectively while maintaining a transparent record of contributions to ensure accountability. This approach also allows for seamless integration with other systems or platforms that may require access to specific versions or updates related to those ideas.

In embodiments, an “idea” represents a concept or knowledge point that can have multiple versions, reflecting various contributions and contexts. Each version is essentially a snapshot of the idea at different stages of its evolution or point of perspective, influenced by the specific insights and expertise of contributors. To tailor the user experience further, the system takes into account several factors when presenting ideas to users. For example, users may have varying levels of access to documents related to an idea based on their roles or permissions within the organization. The system can segment and display different versions of an idea according to these document-level privileges. Further, depending on a user's work environment, they might be more familiar with certain ideas than others. For instance, users in research departments may have access to cutting-edge concepts that are not yet widely known outside their domain. The organizational structure and culture can impact the way ideas evolve within a company. Users from different departments or locations might contribute unique perspectives, leading to diverse versions of an idea.

In some cases, sensitive information may be embedded in certain versions of an idea, making them more restricted than others. The system can filter these versions based on the user's access level. In one example, the system employs advanced techniques such as embedding representations and context-based analysis to determine which version is most suitable for a given user. It generates embeddings (numerical representations) of ideas that capture their semantic meaning in an “embedding space.” By comparing these embeddings with those representing other concepts or knowledge areas known to the user, the system can identify which version of an idea is most relevant based on its similarity to the user's background knowledge and context. This intelligent matching process ensures that users are presented with the ideal version(s) of ideas tailored to their needs and expertise, enabling them to engage effectively in collaborative problem-solving or innovation within the system environment.

In embodiments, an “overall idea” (e.g., idea X) represents a central concept or innovation that serves as a foundation for further exploration and development. Portfolio managers play a crucial role in overseeing these ideas by curating their evolution through different versions and ultimately facilitating the process of transforming them into tangible inventions. The system enables portfolio managers to either create an entirely new idea or reconstruct existing ones based on selected versions that best represent the desired vision for the concept. By choosing which version(s) to use as a starting point, they can establish groundwork and set expectations regarding the direction of development and collaboration among contributors. Once an appropriate combination of ideas has been established, portfolio managers have the option to generate a comprehensive invention disclosure document with just one click. This process allows them to rapidly consolidate relevant information from multiple versions into a single report that can be submitted for patenting or other intellectual property protection. The system enables this streamlined workflow on both individual idea versions and across different combinations of those versions, providing flexibility in how inventions are documented and presented. This feature ensures efficient management of ideas throughout their lifecycle while simplifying the process of transforming them into commercially valuable assets for organizations.

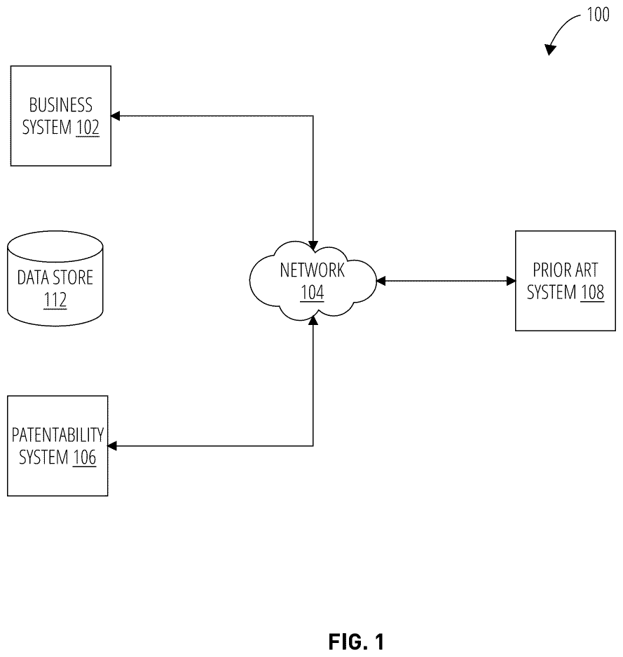

FIG. 1 illustrates an example of a system 100, corresponding to a high-level enterprise architecture including business systems, patentability system, and prior-art system over a network, in accordance with embodiments discussed herein. System 100 includes systems and components that enable users and businesses to identify high-quality patentable assets and file a patent application. At a high level, the system 100 monitors communication medium(s) to identify and score potential Intellectual Property (IP) assets, trigger alerts based on communication content and patentability score, receive invention ideas, and automatically generate a patent disclosure based on a scored idea. The system 100 includes a business system 102, a patentability system 106, and a prior art system 108 coupled via a network 104 to perform the operations discussed herein.

The system 100 illustrates systems coupled via a network 104 to perform the operations discussed herein. In embodiments, the system 100 may include one or more business systems 102, which may be monitored by a patentability system 106. A business system 102 includes a combination of processes, tools, and technologies to achieve specific organizational goals and objectives. These systems streamline operations, improve efficiency, and enhance decision-making. They typically include software applications for areas such as customer relationship management (CRM), enterprise resource planning (ERP), supply chain management (SCM), and human resources management (HRM). Business systems integrate various functions to provide a cohesive view of the organization, facilitating better resource allocation and strategic planning.

The Business System 102 includes computing hardware, including the physical components that support an organization's computing and networking needs. These components are essential for running software applications, storing data, and enabling communication and collaboration. In embodiments the business system 102 includes servers, workstations, desktop computers, laptops and mobile devices. The business system 102 also includes networking equipment such as routers, switches, and firewalls that facilitate communication between computers and secure network operations. The business system 102 also includes storage solutions, such as hard drives, solid-state drives, Network Attached Storage (NAS), and Storage Area Networks (SAN) that provide data storage and retrieval capabilities. The business system 102 may also include auxiliary devices like printers, scanners, monitors, and keyboards that enhance user interaction and productivity. In some embodiments, the business system 102 may be deployed in facilities housing multiple servers and storage systems, ensuring reliable and scalable information technology (IT) infrastructure for larger organizations. These hardware components form the backbone of an organization's IT infrastructure, ensuring the efficient performance and reliability of business systems.

In embodiments, business system 102, including networking, enables communication via one or more communication mediums. The communication mediums are the channels through which information is transmitted from one entity or employee to another. These can be broadly categorized into verbal communication, non-verbal communication, and digital communication channels. As will be discussed, embodiments include monitoring the digital communication channels, such as social media platforms, instant messaging applications, electronic mail (e-mail) and video conferencing tools. A digital communication channel may enable internal and/or external communication to the business system 102, and it is a medium that uses electronic technologies to transmit information and facilitate interactions. The channels may enable real-time or asynchronous communication, connecting individuals and organizations across the various platforms.

In embodiments, the business system 102 enables access to patentability system 106 via network 104. The patentability system 106 monitors communications for invention ideas.

In embodiments, patentability system 106 is configured to monitor the communication mediums of the business system 102, detect patentability ideas, analyze patentable ideas, and provide feedback. The patentability system 106 includes high-performance, scalable physical components designed to support the extensive computing needs of large organizations. These components ensure robust, reliable, and secure operations, which are critical for handling substantial data volumes and complex applications. For example, the patentability system 106 includes one or more servers that manage network resources, host applications, run databases, and provide centralized storage and computing services. Additionally, the system incorporates critical storage and network solutions, such as data store 112. The data store 112 may be a Storage Area Network (SAN) that offer high-speed, block-level storage essential for enterprise-level data management. Network Attached Storage (NAS) provides dedicated file storage connected to a network, allowing multiple users to access and share files seamlessly.

The data store 112 may include a database to store ideas. The data store 112 may store ideas in accordance with a data schema. In one example, the database more store information, such as a user identifier to identify the idea's contributor, a title, an access level indicating which level of users can access the idea, a unique identifier to identify the idea, a link or location to the submitted idea data (e.g., a file, document, text description, audio file, etc.), a date, and other data.

In embodiments, the data store 112 is designed and configured to function as a comprehensive repository for storing various attributes associated with each idea, such as contributor information, metadata, access levels, unique identifiers, and links to related data sources like files or documents. The database within the data store 112 adheres to a specific “data schema,” which defines how different pieces of information are structured and stored. This schema ensures consistency across all records in the system while providing flexibility for future enhancements and updates. Key components included in the data store's schema include a user identifier (ID), Each idea is associated with a unique contributor, identified by their user ID or other identifying information. This allows the system 100 to track the origin of ideas and attribute credit where it is due. The data store 112 may also store a title and access level. The title provides an overview of the idea's subject matter, enabling easy identification and retrieval from within the system. Further and by defining access levels for each idea (e.g., public, internal, restricted), the system 100 can determine who has permission to view or interact with a specific concept based on their organizational roles and responsibilities, granted access level, etc. The data store 112 also stores each idea with a unique identifier. Each idea is assigned a unique ID that serves as a reference point across the system's various components, allowing for consistent identification and cross-referencing of related data points. The data store 112 also stores links to associated documents or resources (e.g., files, text descriptions, audio recordings) relevant to the idea. This integration ensures that users can access all necessary information in a single place while maintaining an organized and structured approach to knowledge management. In some instances, the data store 112 may store a submission date for the contribution or idea. Ideas are timestamped with their creation date, allowing for chronological tracking of development progress and facilitating historical analysis or auditing purposes when needed.

The patentability system 106 provides a graphical interface (GUI) that simplifies the submission and documentation process for inventors. This feature enables users to submit their invention ideas using various file formats such as documents, video files, audio files, or plain text. The patentability system's GUI is designed with a range of functionalities tailored to accommodate different user preferences and workflow requirements. For example, the patentability system 106 provides a Drag-and-drop feature: This intuitive method allows users to directly upload their idea documents by dragging them onto the designated area within the GUI. The system recognizes file types, validates formats, and prepares files for processing while providing real-time feedback on any errors or warnings that need attention before submission. In some instances, the patentability system 106 provides an upload button. The upload button provides a straightforward way to select files from their local storage and send them directly to the patentability system 106 for evaluation and inclusion in the data store 112.

The patentability system 106 receives a file, document, text, etc., and performs a thorough examination by automated tools that assess its novelty, inventiveness, and potential patentability based on established criteria and algorithms. This preliminary evaluation helps to determine whether further review is necessary. In embodiments, the patentability system 106 determines whether a submission is for a new idea or an already submitted idea. For example, the patentability system 106 may apply a Euclidean distance analysis to the submission to determine the distance between it and other submissions. If the distance exceeds the threshold distance, the idea may be considered a new idea. If the distance is within a threshold distance, the patentability system 106 relates the submission to the other submissions within the distance threshold and is directed to the same idea. The patentability system 106 also generates a new record in the data store 112 (as described earlier) that encapsulates all pertinent information about the idea. This includes details such as user identifiers, titles, access levels, unique identifiers, and links to associated resources.

The patentability system 106 incorporates a robust access control mechanism to manage user permissions and facilitate collaborative innovation across multiple submissions for the same idea or invention. This system ensures that each submission is appropriately protected while also enabling seamless collaboration among users with different roles, responsibilities, and levels of expertise within an organization's intellectual property ecosystem.

The access control model implemented by the patentability system 106 may include several components. In embodiments, the patentability system 106 includes a component to assign unique access levels to each user based on their organizational role or assigned permissions, ranging from lower-level (e.g., level 1) for general users to higher-level (e.g., level 5) for more privileged contributors such as patent attorneys or department heads. These access levels dictate the extent of information and resources a user can view, modify, or share within the system. When multiple users submit an idea under consideration, each submission is assigned its own unique identifier along with associated metadata, including the contributing user's access level and any relevant notes on their contribution.

The patentability system 106 manages user access. For example, users at higher-level access (e.g., level 2 or 3) are granted broader visibility into the idea's submissions, allowing them to review and assess different versions of an invention concept across different contributors while maintaining a record of each individual's input. In another example, the patentability system 106 may limit users to specific access levels. For example, a user may only be able to access submissions having the same access level, e.g., level 2 can access level 2 submissions. In other instances, the access level may be a hierarchal system, where users with a higher level of access can access all submissions on the same level and lower levels.

The patentability system 106 also provides administrators with tools to manage access levels, monitor submissions, and enforce compliance with established intellectual property policies and guidelines. These features enable them to maintain an organized record of contributions while ensuring that sensitive information is protected from unauthorized disclosure or misuse. By implementing this comprehensive access control model, the patentability system 106 facilitates a secure environment for users to collaborate on ideas and inventions without compromising individual contributions or intellectual property rights. The flexibility in defining user roles and permissions allows organizations of various sizes and industries to tailor their innovation ecosystems according to specific business needs, fostering an atmosphere of trust and accountability among all stakeholders involved in the ideation process.

The patentability system 106 also streamlines the process of generating an inventor's disclosure form. This feature is particularly beneficial for users who are seeking to protect their intellectual property through patents. By providing a one-click method on the Graphical User Interface (GUI) interface, the patentability system 106 significantly reduces the time and effort required to create a comprehensive invention disclosure document. The system works by analyzing various submissions related to an idea or innovation made by users, which could be stored in different formats as discussed. Depending on user preference or automated decision-making algorithms, the patentability system 106 selects relevant submissions that will contribute to constructing a well-rounded disclosure form. The selection criteria for generating the disclosure form can be tailored by users based on factors such as the patentability of content within each submission, ensuring only those with potential for successful patent applications are included in the final document. Other factors include detail-oriented aspects like technical specifications and descriptions that clearly understand the innovation's uniqueness. The selection of criteria also includes the contributors, e.g., submissions of more prolific inventors may be incorporated into the disclosure. Another factor includes submission dates, which can help establish the timeline for developing the idea or invention. Business factors such as market potential or commercial viability, if applicable may also be factors. By incorporating these criteria into its decision-making process, the patentability system 106 ensures that only pertinent and promising submissions are considered when generating an inventor's disclosure form. This ultimately aids in creating a robust application for intellectual property protection while minimizing potential issues related to incomplete or irrelevant information.

The patentability system 106 is configured to analyze and process submissions selected to generate a disclosure form, ultimately synthesizing these inputs into a comprehensive invention disclosure form. This form serves as the foundational document for filing a patent application, detailing essential information about an innovation or idea. The system's capabilities extend to generating content for various fields of the disclosure form, including a problem statement clearly articulating the issue or gap that the invention seeks to address or resolve. The patentability system 106 also generates a solution description, detailing the proposed solution and its underlying principles or mechanisms and a detailed description elaborating on technical aspects such as design, materials, process, and functionality of the invention. The patentability system 106 also identifies and provides prior art-identifying related existing patents, publications, or public disclosures that could affect the novelty or inventiveness of the submission. The patentability system 106 can also include inventor information including the identity and contributions of all individuals involved in developing the idea. The patentability system 106 also include one or more submission dates based on the dates of the submission, recording when each individual submission was made to facilitate a chronological understanding of the development process.

To efficiently generate content for these fields, the patentability system 106 may incorporate advanced technologies such as generative artificial intelligence (AI). By utilizing AI algorithms and natural language processing techniques, the patentability system 106 can automatically create coherent and relevant text based on the analyzed submissions. For instance, when generating a problem statement or solution description, the system might analyze multiple submissions to identify recurring themes, technical terms, and key concepts related to the invention. The patentability system 106 then synthesizes this information into a well-structured narrative that effectively presents the innovation's purpose and benefits. Similarly, for prior art identification, the patentability system 106 using the AI can compare textual data from submissions against vast databases of existing patents, publications, or online content to identify potential overlaps with preexisting technologies. The patentability system 106 also allows users to customize the generated content by selecting specific submissions that should be included in different sections of the disclosure form. Overall, the patentability system 106 and its generative AI component offer powerful tools for inventors seeking intellectual property protection. By streamlining the creation process, improving accuracy, and providing a thorough analysis of submissions, this technology serves as an invaluable asset for inventors looking to secure their innovations through patents.

In embodiments, the system 100 includes a network 104 to enable communication. For example, the system 100 includes essential networking equipment like routers and switches that facilitate data traffic management, ensuring optimal performance and connectivity. Firewalls and security appliances are integral components that protect the network from threats and unauthorized access, maintaining the integrity and confidentiality of critical data. Together, these elements form a comprehensive infrastructure capable of supporting the demanding requirements of large enterprise business systems, ensuring that data is processed, stored, and transmitted efficiently and securely.

In embodiments, system 100 includes a prior art system 108, which may be utilized by patentability system 106 to identify related prior art for ideas identified from business system 102. The prior art system 108 includes a data store or a data repository that stores existing knowledge, technology, inventions, or publications that are relevant to the novelty and originality of a new invention or patent application. It includes anything made available to the public before a given date, such as patents, published patent applications, scientific papers, products, and other forms of documentation. Prior art can be used to assess whether an invention is new and non-obvious, which are critical criteria for patentability.

In one example, the prior art system 108 may include the United States Patent Office (USPTO) databases of patents, patent applications, and non-patent literature. The prior art system 108 may include a third-party database, such as Google's® patent database. Other prior art system 108 include other Internet databases including other patent databases (such as the EPO, and WIPO), scientific publications and journals (like PubMed, IEEE Xplore, SpringerLink, ScienceDirect, and ResearchGate), technical documentation (including standards and company white papers), online repositories and libraries (like arXiv, JSTOR, and the ACM Digital Library), industry publications (such as trade journals), and other sources (like theses and archived websites). These sources collectively provide comprehensive coverage of prior art across various fields and industries and may be accessed by the patentability system 106 to perform the operations discussed herein.

In embodiments, the prior art system 108 includes other data stores, such as company corpuses, storage or websites like confluence. By incorporating internal corporate repositories, which house patents, trade secrets, and other intellectual property assets held by the company or organization, embodiments can cross-reference novel concepts against in-house data. This integration helps identify potential conflicts of interest, assess competitive advantages, and avoid redundancy within a single entity's portfolio. Some embodiments may utilize data solutions and platforms such as Confluence that provide collaborative environments where information is centralized and easily accessible to various stakeholders involved in the innovation process. By linking with these platforms, the prior art system 108 can draw on collective insights, documented ideas, research notes, and project updates that may be pertinent to evaluating new concepts. The prior art system 108 may gather data from other websites. In addition to curated databases, external websites offer a wealth of information not confined within proprietary systems. By incorporating data from these sources—including open-source repositories, academic journals, industry publications, and more—the prior art system gains access to a broader spectrum of relevant knowledge that could influence the assessment of new ideas' originality, innovation level, and potential market impact.

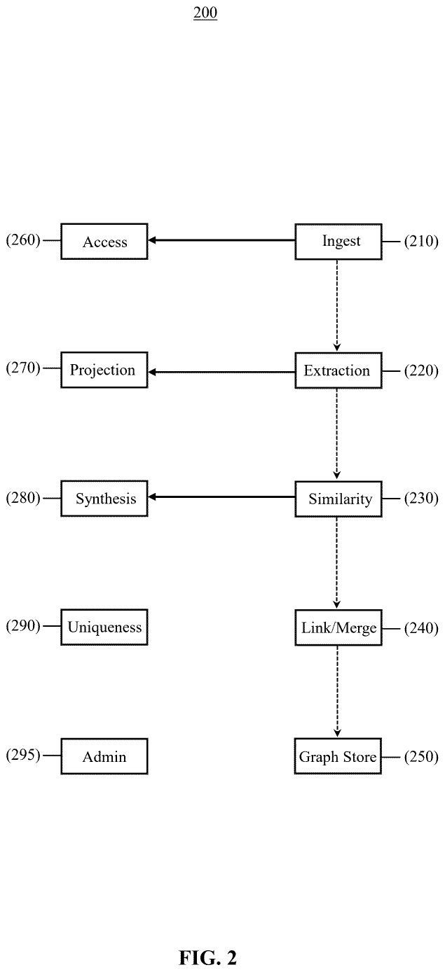

FIG. 2 illustrates an example block diagram of a system architecture for constructing and serving an access-controlled idea graph. The exemplary functional overview 200, illustrated in FIG. 2, is directed to an integrated system designed to manage intellectual property by identifying, processing, and synthesizing ideas. A core function of the system is to receive or identify ideas, determine if they are conceptually related to other existing ideas, and store them with relational links. The aforementioned system further enables the use AI to automatically generate a comprehensive disclosure or summary by synthesizing data from these interrelated submissions based on a user's query and access level.

One feature, associated with the example system implementation 200, is idea ingestion and identification functionality. The system may acquire ideas in two primary ways, namely via a direct user submission, whereby a user can directly input idea submissions into the system (e.g., using a idea submission API and/or portal) and a document parsing feature which may be operationalized to connect to data repositories like a SharePoint and/or Google Drive, parse documents within the accessed data repositories, and automatically find and extract one or multiple inventive ideas contained in the text. Accordingly, with reference example 200, an ingest layer 210 is implemented, for example, via an interface to ingest submissions and/or parse documents to extract ideas. The ingest layer may further comprise connectors to repositories (e.g., email, cloud drives, code hosting, ticketing systems) and a submission API. As part of the idea ingestion and identification functionality, an extraction process/module 220, operating in conjunction with the ingestion process may segment and parse the retrieved text to facilitate evaluation of idea spans, for generating candidate idea objects.

Another feature of the example system implementation 200 involves connection and inter-linking of related ideas across submissions and parsed documents. The system analyzes new idea submissions and determines if they are conceptually the same as or related to previous submissions. In one embodiments, similarity analysis may be primarily based on embeddings and vector distance computations. In some embodiments user-generated tags may be used to lighten computational load. In this way, when a user queries a topic, the system considers the context of all related documents and ideas. As such, with reference to example 200, similarity engine 230 encodes extracted ideas, derived from ingested data inputs, via embeddings to compute pairwise similarity.

Another feature of the example system implementation 200 involves version control and idea evolution (e.g., using an idea graph) for generating updated, merged representations of similar and/or equivalent ideas. The system tracks the evolution of an idea. When a new document or submission contains an idea that is very similar but slightly different from an existing one, the system merges them. This merger represents an evolution of the idea, effectively creating a new version. Referring back to example 200, a link/merge controller 240, working in conjunction with similarity engine 230, links and/or merges ideas into a versioned idea graph—the link/merge module 240, based on analysis of the content and metadata associated with an extracted idea object, may further decides on a type of relational link to generate between a current idea object and one or more existing ones. For example, the link/merge module 240 may create an equivalence or a succession relational link between the current idea object and one or more existing ones. In some instances, the link/merge module 240 may determine that an idea object represents a next iteration of an existing idea and accordingly decide to merge the two idea objects (e.g., corresponding to two nodes in the idea graph). Example system overview 200 further illustrates a graph store 250 for persisting nodes, relational links, and provenance information associated with different idea objects.

Yet another feature of the example system implementation 200 involves access gating and permissioning functionality. This functionality provides access-gated views in response a user inquiry such that each user sees only idea permutations they're entitled to. The system employs a sophisticated access control mechanism. A user's ability to see an idea is determined by their access rights to the underlying source documents from which the ideas were generated. A user with a higher access level (e.g., a portfolio managers) can see the merged/global view. Referring back to example 200, an access service 260 evaluates policies derived from source references, provided via the data ingest process 210 and/or retrieved from a data store, in order to generate user-specific permutations of the idea graph from source permissions.

Referring back to example 200, a projection engine computes a permutation view which enables different users or groups to see different, contextually created versions of an idea based on the documents they have access to. For example, if two groups work on a similar concept independently, they will each see their own version of the idea (A and B). A user with higher-level permissions, such as an IP portfolio manager, can see a merged version (C) that combines the related but separately-developed ideas (A and B). This manager has access even if they did not submit any of the source material. A synthesis module 280 may then automatically generate a disclosure, responsive to a user query, from the accessible subgraph (e.g., linked items to which a querying user has access).

The system (e.g., system 200) can also generate a uniqueness score, using a uniqueness scorer 290 for an idea. This score is determined by analyzing the embeddings and calculating the density of similar ideas within that conceptual space. This score can be assigned to either an individual idea or the overarching topic that groups multiple submissions. In some embodiments, a merging of idea objects may further initiate updating of the pointers so a portfolio-level views surface the merged form while user-level views remain access-filtered. As illustrated in example 200, the system may further comprise an administrative console 295.

Alternative embodiments include tag-assisted matching to reduce computational cost. The system optionally assigns a uniqueness score to ideas or clusters based on neighborhood density in an embedding space. Training and inference components implement the extraction, linking, merging, and synthesis workflows, with administrative roles (e.g., portfolio manager) enabled to view merged, organization-wide versions.

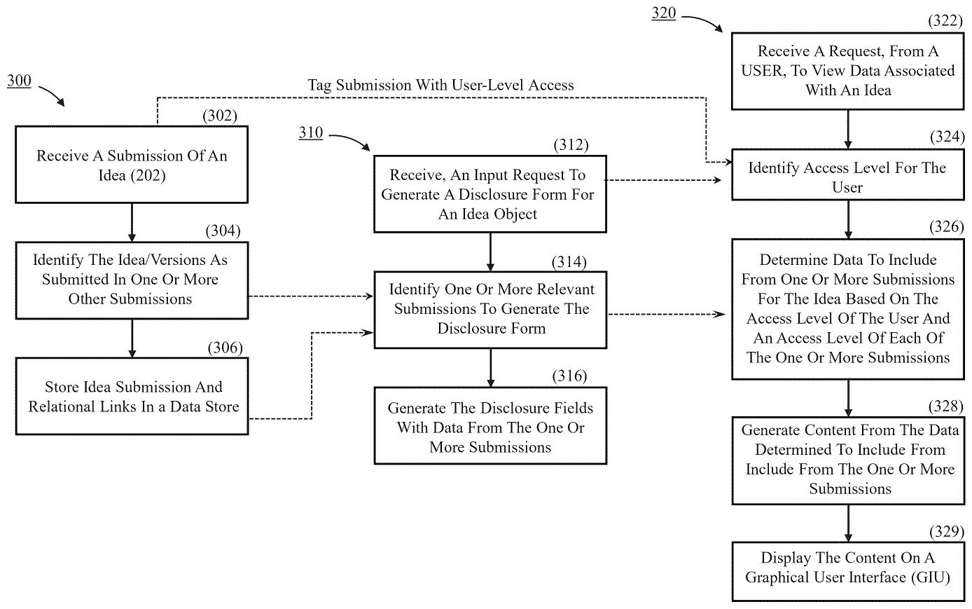

FIG. 3 illustrates an example of a routines 300, 310 and 320, in accordance with some embodiments of the present disclosure. Routine 300 describes an exemplary implementation of idea submission, ingestion and relational link generation. Routine 300 begins when a contributor provides a submission through a designated input channel such as email, chat integration, or a web interface. The system normalizes the submission, extracts textual and non-textual artefacts, and generates embeddings. A similarity computation is performed against existing submissions stored in the data store. If no match is found above a configurable threshold, the submission is classified as a new idea and assigned a unique identifier. Otherwise, it is linked to the nearest matching submission(s) and marked as a version of an existing idea. Metadata including contributor identity, timestamp, submission type, access level, and relation links are persisted in the governed schema (e.g., a schema that is subject to a set of rules, policies, and processes designed to ensure data quality, consistency, and compliance to ensure that the integrity and useability of the data, defined by the schema, is maintained throughout its lifecycle). Cross-connections between unrelated ideas may also be recorded if shared contributors or overlapping artefacts are detected.

Referring back to routine 300, illustrated in FIG. 3, in block 302, routine 300 receives, by a system, a submission of an idea. Specifically, routine 300 refers to the action taken by patentability system 106 when receiving a submission of an idea or invention from an individual user via a document or file submission. The patentability system 106, receives a submission of an idea it may perform one or more processes. The patentability system 106 collects relevant data from the user's input, such as textual descriptions, drawings, or other multimedia content that depicts the innovation. The patentability system 106 also screens the submission for completeness.

In block 304, routine 300 identifies, by the system, the idea as submitted in one or more other submissions. In embodiments, this step ensures a comprehensive analysis of all available information regarding the innovation, which contributes to generating a well-informed disclosure form. In embodiments, the patentability system 106 integrates data from various submissions made by multiple users or sources related to the idea in question. This could include previous drafts, research notes, technical sketches, and other forms of documentation that have been previously submitted. By comparing new submissions with existing ones using advanced algorithms and natural language processing techniques, patentability system 106 identifies overlaps or connections between different ideas or concepts. Once related submissions are identified, patentability system 106 creates a network of relationships among various pieces of information, allowing users, e.g., a portfolio manager, to understand how an idea fits within an existing body of knowledge and innovation landscape.

In block 306, routine 300 stores, by the system, data associated with the submission in a data store and a relationship relating the submission to the one or more other submissions. In embodiments, the patentability system 106 collects and stores various types of information associated with each submission, as discussed. In addition, the patentability system 106 may also store textual descriptions, drawings, technical specifications, multimedia content, etc. This comprehensive data repository ensures that all relevant aspects of an invention are documented for future reference or analysis. In embodiments, the patentability system 106 establishes a connection between the current submission and previous submissions related to similar ideas or concepts or identifies the submission as a new idea. By creating these relationships, the patentability system 106 can track how an idea evolves over time and identify any potential overlap with prior work in progress and apply access control management.

Alternative embodiments include tag-assisted matching to reduce computational cost. The system optionally assigns a uniqueness score to ideas or clusters based on neighborhood density in an embedding space. Training and inference components implement the extraction, linking, merging, and synthesis workflows, with administrative roles (e.g., portfolio manager) enabled to view merged, organization-wide versions.

Routine 310 describes an exemplary implementation of disclosure generation comprising receiving a user request. selecting relevant submissions and generating disclosure field using, for example, an generative AI process. Routine 310 is triggered when a user initiates a portfolio action, such as a one-click request to prepare a disclosure. The system identifies the relevant idea and retrieves all associated submissions. For each submission, metadata and artefacts are loaded, subject to access-level checks. The system invokes a generative AI model trained on disclosure structures to synthesize content such as title, abstract, problem statements, solution descriptions, inventor attributions, timelines, and predicted classifications. The AI output is presented in a draft disclosure form with editable fields, enabling users to adjust or confirm content. Prior art references, if integrated, are appended to the disclosure package.

Referring back to routine 310, illustrated in FIG. 3, in block 312, routine 310 receives, by a system, an input to generate a disclosure form for an idea. For example, a user may utilize a GUI to submit a request to generate the disclosure form. The patentability system 106 includes a graphical user interface (GUI) that provides an intuitive and efficient means for users to submit requests and interact with the patentability system 106. Through a GUI, users can submit requests to generate disclosure forms by providing necessary information directly within an interface, reducing errors or omissions commonly associated with manual data entry methods.

In block 314, routine 310 identifies, by the system, one or more submissions to generate the disclosure form. For example the patentability system 106 analyzes various inputs, such as textual descriptions, drawings, technical specifications, or other relevant data sources provided by an inventor or a team of collaborators as submissions for the idea. In one example, a user may identify submissions to utilize. In another example, the patentability system 106 identifies submissions that are most relevant to the invention being documented. For example, the patentability system 106 evaluates related submissions and determines their relevance based on factors such as similarity in technology or conceptual overlap with the current idea. This analysis helps ensure that all significant aspects of an invention are considered during the documentation process. Once relevant submissions have been identified, the patentability system 106 collects and integrates their information into a unified context for disclosure form generation. By consolidating data from multiple sources, the patentability system 106 creates a more accurate and comprehensive representation of the idea.

In block 316, routine 310 generates, by the system, the disclosure with data from the one or more submissions. For example, the patentability system 106 may apply generative AI techniques to the data of each identified submission to generate a disclosure form. Incorporating generative AI techniques into the patentability system 106 enhances the system's ability to generate disclosure forms by leveraging machine learning algorithms. These advanced technologies enable more accurate, comprehensive, and efficient documentation of inventions. In embodiments, the patentability system 106 utilizes generative AI algorithms to automatically generate textual content for disclosure forms based on input data from submissions. This may include summaries, descriptions, or other relevant sections that require high levels of detail to convey the invention's essence and novelty accurately. Further, by utilizing generative AI techniques, the patentability system 106 can automatically customize disclosure forms for each submission based on specific requirements set by users. This flexibility allows the system to produce tailored documents that address individual needs while maintaining compliance with legal standards and regulations.

Routine 320 describes an exemplary implementation of access-evaluation, per-submission filtering disclosure package assembly and data presentation on a GUI display. Routine 320 enforces access control prior to displaying submission data. The system determines the user's role and associated access level, then compares it against the submission-level restrictions. Only submissions meeting both criteria are included in the viewable set. The filtered set is aggregated into a content package, which may include AI-generated summaries, contributor networks, analytics, and prior art links. The graphical user interface displays the package in a structured manner, with tabs for versions, analytics dashboards, and disclosure readiness. Confidential fields may be redacted automatically depending on the user's role.

Referring back to routine 320, illustrated in FIG. 3, in block 322, routine 320 receives, by a system, a request to view data associated with an idea by a user. For example, a user, such as an inventor, a business manager, or a portfolio manager may submit a request to view information or submission data associated with an idea. Moreover, the patentability system 106 retrieves data linked with an idea that has been previously submitted or inputted by one or more users. The request can originate from various professional roles, such as inventors who wish to review their patent applications, business managers seeking insights into marketing strategies, or portfolio managers needing to assess investment opportunities tied to specific ideas or projects. This process ensures that users have access to relevant information for decision-making and analysis purposes in a timely and efficient manner.

In block 324, routine 320 identifies, by the system, an access level for the user. In some instances, the system also determines access levels for one or more submissions for the idea. Embodiments, include the patentability system 106 evaluates and assigns user access levels based on predefined security protocols and permissions or user selections to users. This process is crucial in protecting sensitive data while ensuring that users can only view information pertinent to their roles or responsibilities within a project or organization. Additionally, this routine extends its functionality by assessing the access privileges associated with submissions related to an idea or concept. These access levels are used to determine which data from which submissions are used to generate a display for the user submitting the request at block 322.

Specifically, and in block 326, routine 400 determines, by the system, data to include from one or more submissions for the idea based on the access level of the user and an access level of each of the one or more submissions. The patentability system 106 takes a tailored approach to data retrieval by considering both the user's access level and the corresponding levels associated with each submission related to an idea. This ensures that users are presented with pertinent information while respecting privacy boundaries determined by the access levels. For example, if an inventor has a mid-level access level to an idea, the patentability system 106 will filter out sensitive data requiring a higher-level access level. Further, when an idea involves multiple submissions from various contributors with different levels of clearance, the patentability system 106 dynamically adjusts the display of information based on these individual permissions. This selective disclosure enhances security and streamlines user experience by preventing unnecessary exposure to irrelevant and confidential data, thereby optimizing productivity and fostering a secure collaborative environment within research and development settings.

In block 328, routine 320 generates, by the system, content from the data determined to include from the one or more submissions. The patentability system 106 processes data from each of the submissions the requester is permitted to see through a generative AI process to generate comprehensive content of the submissions in a single display. The patentability system 106 employs advanced data processing techniques to synthesize comprehensive content from the selected submissions. For example, the patentability system 106 utilizes generative AI processes to create a coherent and detailed representation of multiple contributions or submissions related to an idea or project. By presenting data in this consolidated form, the patentability system 106 facilitates a more efficient decision-making process for stakeholders who need to grasp complex information quickly and accurately. In block 329, routine 320 displays, by the system and on a display, the content in a graphical user interface (GUI). The patentability system 106 integrates generated content into a graphical user interface (GUI) display. This step involves transforming complex datasets from the submissions and AI-generated insights into an accessible and interactive format that users can easily interpret.

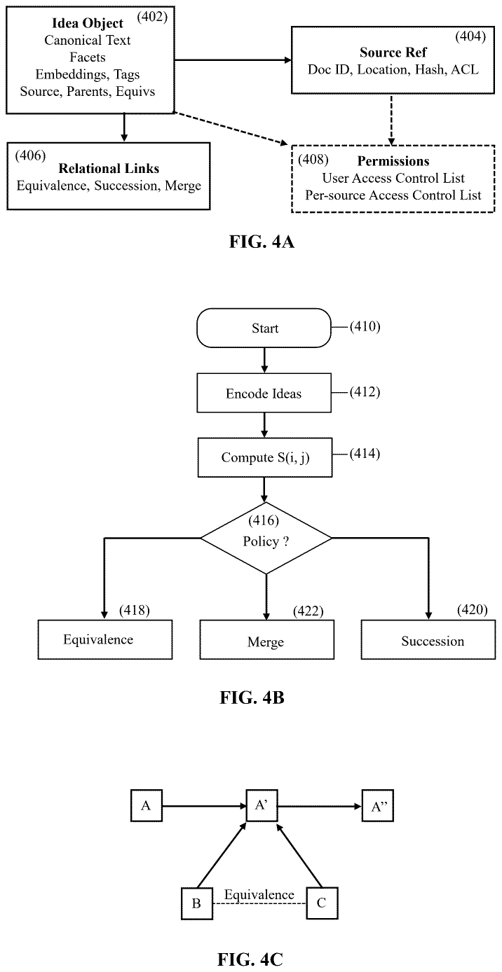

FIG. 4A illustrates a data model for idea objects 402, source references 404, relational links 406 (which may be used in some embodiments for determining a semantic boundary of an idea with respect to the available data), and permissions 408. As shown in FIG. 4A each idea object 402 may store an identifier, canonical text, one or more structured facets (e.g., problem/solution), sources (e.g., document identifier, location, hash, Access Control List), parent sources (e.g., succession links), equivalent, merged into (if node is merged) and other parameters such as created By, created At, embeddings, and tags. Each relational link may carry a type attribute, and other parameters such as a confidence score, created At, created By, policy (e.g., in case the relational link itself carries policy), and provenance (e.g., matching features). In some embodiments, the graph store maintains lineage so that a merged node retains pointers to antecedent nodes and their sources.

The corresponding text may be segmented and passed to models that predict idea spans and normalize them to a canonical form (e.g., lemmatization, acronym expansion, component typing). In some embodiments, a rules engine may supplement the model with domain heuristics (e.g., patterns for “: system comprising,” “embedding distance,” “role-based access”). The output may correspond to a set of candidate idea objects with associated source references.

FIG. 4B illustrates a flowchart of similarity computation and link-or-merge decisioning. The system may receive one or more idea submission at 410 and generate an embedded representation of the extracted idea (e.g., idea i and idea j) at 412. At 414, the system computes a similarity score S(i, j) for idea objects i and j (e.g., similarity score may be calculated for an embedded version, e(i) and e(j), of idea objects i and j). In some embodiments similarity computation may be augmented by lexical overlap, facet agreement, and tag matches. A decision policy 416 determines one of: (A) link as equivalence (e.g., relational link 418), (B) link as succession (e.g., relational link 420), (C) merge (e.g., relational link 422), or (D) no action.

In some embodiments, an example policy may prescribe creation of an equivalence relational link if tags intersect with high weight. Furthermore, if temporal order indicates that a first idea (e.g., idea i) preceded a second idea (e.g., idea j) and features indicate refinement (e.g., added constraints), the example policy may prescribe creation of a succession relational link. Another policy criteria may prescribe that if both content parity and provenance overlap exceed a predetermined merge idea i and j into a new version (e.g., idea k) while preserving antecedent pointers. In some embodiments, adaptive thresholds may be implemented that are informed and updated based on feedback data (e.g., user confirmation). FIG. 4C illustrates a versioned evolution graph with succession and equivalence relational links. Merging creates node k with unified fields and a version vector recording lineage (A→A′→A″). Edges to i and j are redirected to k.

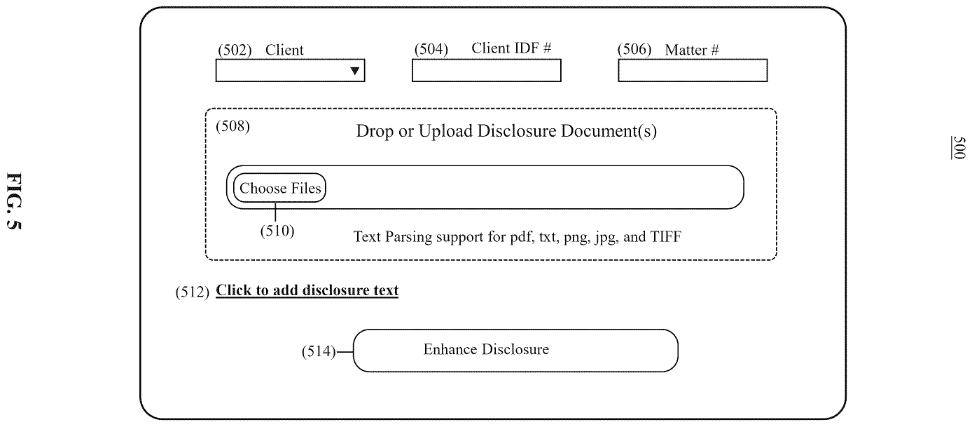

FIG. 5 illustrates an example of a display 500 in accordance with the embodiments discussed herein. The display 500 serves as a comprehensive interface designed for inventors or users to submit various types of disclosure documents, including but not limited to document files (doc, docx, PDFs), text files (.txt), audio files (.wav, .mp3), and image files (.jpg, .png). This versatile platform facilitates the submission process by providing an array of functionalities. Key features comprising the display 500 include a client drop-down menu (502): A user-friendly interface that allows users to select their client or project from a predefined list, or add a new client. The display 500 also includes a client disclosure number field (504): This input area enables the inventor or user to assign a unique identifier to each submitted disclosure document associated with specific clients, ensuring accurate tracking and retrieval of documents in future interactions. The display 500 includes a law firm docket number field (506): A dedicated section for users to enter their law firm's docket number when submitting disclosures, which aids in maintaining comprehensive records between inventors, users, and legal representatives throughout the disclosure process. The display 500 includes a drag-and-drop area (508): A convenient feature that allows users to easily drag and drop files into the designated submission window without having to navigate through their computer's file system or use additional software for uploading documents. However, the 500 also includes an upload disclosure button (510): This user interface element enables inventors or users to seamlessly submit their disclosure documents by selecting them from their local storage and initiating the upload process directly within the display 500 environment. In some instances, the display 500 includes a paste text link 512 providing a direct access option for users, allowing them to paste this content into designated fields without having to retype it manually. The display 500 also includes an advanced disclosure techniques button (514): This feature provides inventors or users with access to advanced tools and methods that can assist in enhancing the quality of their disclosures, such as auto-formatting text, generating tables/charts from data sets, and utilizing other specialized software integrations.

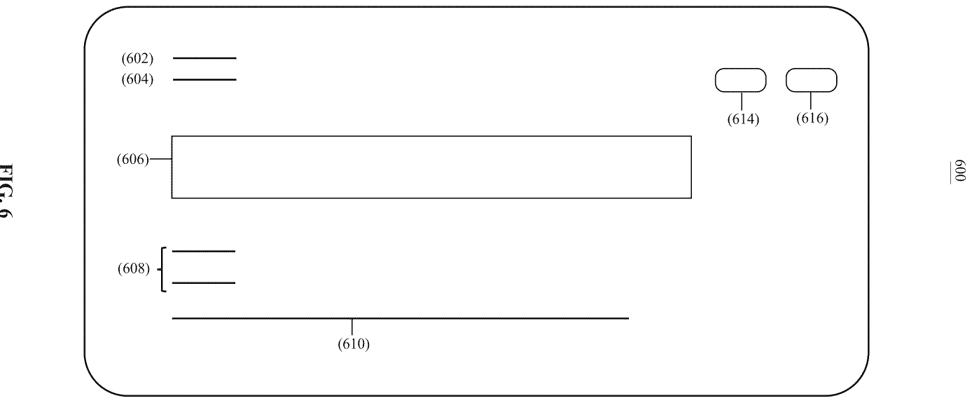

FIG. 6 illustrates an example of a display 600 in accordance with embodiments. Display 600 is one example display that may be presented once disclosure information is submitted, i.e., a submission. The Display 600 is a comprehensive platform designed to provide inventors and users with an intuitive interface for managing their disclosure submissions, while also offering valuable insights through analysis statistics. The following sections are integral components of this display: 1. Title section 602: This area presents the title or heading associated with each submission, providing a concise summary of its content and purpose. 2. Inventors' section 604: A dedicated space for inventors to display their personal information such as name, contact details, and affiliation, allowing them to maintain an organized record of all disclosures made under their names. 3. Summary section 606: This feature condenses the key points from a submission into a brief, reader-friendly summary that can be easily reviewed by others who may not have access to the full document. The display 600 also includes an analysis statistics area (608), which is a comprehensive suite of metrics and indicators to help inventors gain insights into their submissions' performance and potential impact. For example, the analysis stats 608 may include a discussion threads indicator that tracks the number of discussion threads generated by each submission, providing an overview of engagement levels within the community or group reviewing the disclosure documents, an experts indicator that shows whether any subject matter experts have provided feedback on the submitted document(s), indicating its relevance and potential for further analysis. The analysis stats 608 may also include a followers indicator, which indicates the number of users who are following or keeping track of an inventor's submissions, highlighting their popularity within the community. The analysis stats 608 also includes a uniqueness score, a numerical value assigned to each submission based on a proprietary algorithm that assesses its novelty and originality compared to existing disclosures in the system, a value score that is another metric provided by an internal algorithm, which quantifies the overall importance or impact of a submission within its respective industry, business, or field. The analysis stats 608 also includes an expert indicator that indicates whether subject matter experts have contributed, reviewed, and commented on the document(s). The analysis stats 608 also includes an innovators indicator that may indicate how many innovators have provided features, technologies or solutions in the submission, reflecting. In embodiments, the analysis stats 608 also includes a unique identifier 610 that is an automatically generated alphanumeric string that serves as a unique reference code to identify each disclosure document submitted through Display 600 uniquely. The display 600 also includes a close button (614): A user interface element enabling inventors or users to close their current session and exit the display, ensuring proper closure of all open files and promptly saving any unsaved changes. In embodiments, the display 600 includes an add file(s) button (616): allows inventors or users to add additional disclosure documents into a single submission by dragging and dropping them into designated areas within Display 600, streamlining the process of managing multiple submissions at once.

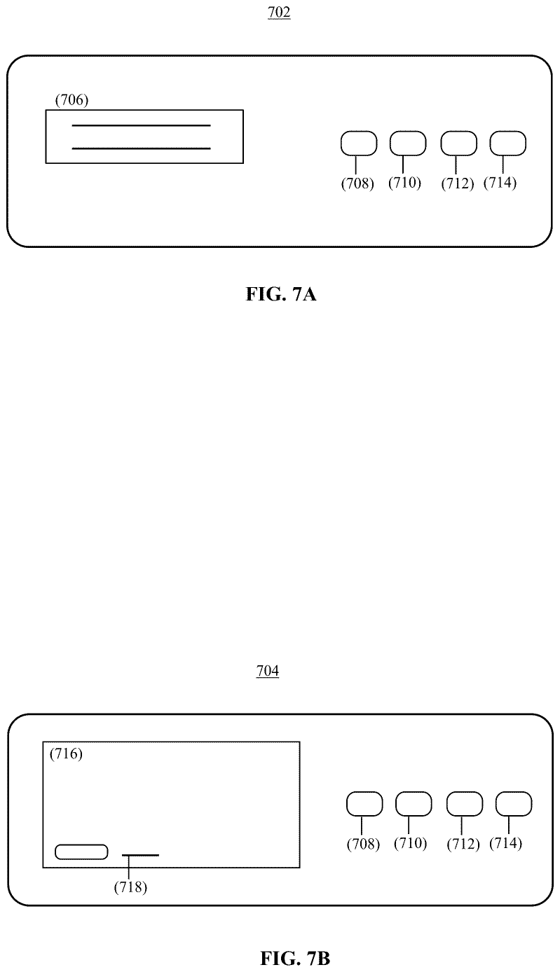

FIG. 7A illustrates an example of a GUI display 702 in accordance with embodiments. The display 702 includes a title 706, a close button 708, an add file(s) button 710, a dynamic form button 712, and an AI generate form button 714. In embodiments, the title 706 is a prominent area where the name or title of each disclosure document is displayed prominently, providing a clear indication of its content at a glance. The close button 708 is a user interface element allows inventors and users to terminate their active session on Display 702 securely, ensuring that all open files are saved accurately before closing the application. The add file(s) button 710 is a convenient feature enabling inventors or users to add additional disclosure documents into a submission by dragging and dropping them into designated areas within Display 702, simplifying the process of managing multiple submissions simultaneously. The dynamic form button 712 is an interactive element presents an adaptive, customizable form based on user input or predefined criteria. It enables inventors to create forms that can dynamically update fields and options as required by their specific needs, enhancing the efficiency of data collection and entry. The AI generate form button 714 is an advanced feature powered by artificial intelligence technology that allows users to generate disclosure documents or input forms based on machine learning algorithms trained on a vast dataset. In embodiments, the AI generate form button 714 determines one or more submissions for an idea to utilize when generate the disclosure form. The submissions are selected based on the access levels of the submissions and the access level of the user generating the disclosure form, as previously discussed.

FIG. 7B exemplifies a modernized representation of Display 704, closely resembling the functionality and design principles outlined in Display 702 while incorporating additional features catering to inventors' needs for efficient document management and analysis. Display 704 includes an AI-generated summary 716, which is the AI-generated summary area, which utilizes machine learning algorithms to automatically generate a comprehensive and concise summary of disclosure documents based on their content. This allows inventors to quickly grasp the essential aspects of each submission without having to manually create or review lengthy summaries, saving valuable time while maintaining accuracy in document representation. Display 704 also includes a file(s) list 718, which is a dedicated file management section that provides users with an organized and easily navigable list of all the disclosure documents associated with their account or project.

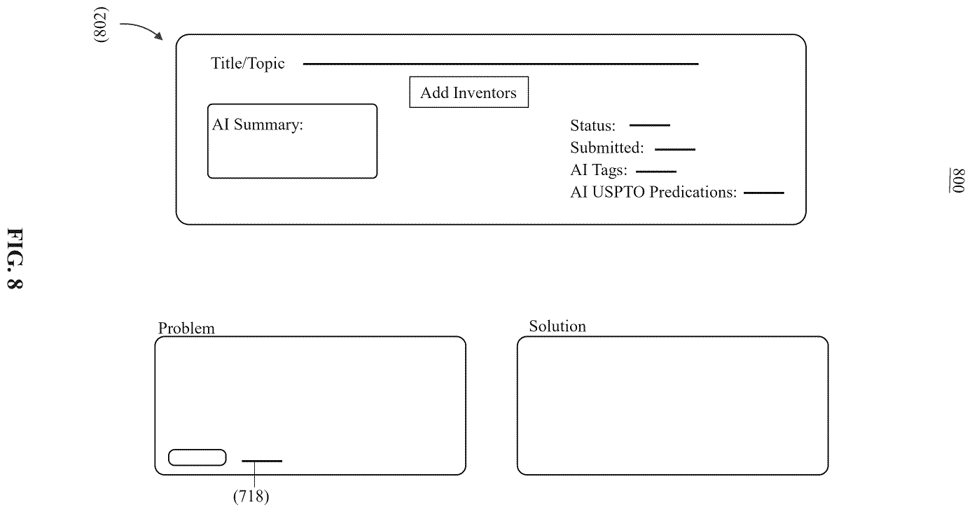

FIG. 8 presents a sophisticated iteration of Display 800, which integrates an AI-driven disclosure form 802 as a central component to enhance the efficiency and accuracy of inventors' submissions management processes. As discussed, the AI-generated disclosure form 802 encompasses various sections generated by artificial intelligence algorithms based on prior disclosures and access levels defined within the system. In embodiments the AI-generated disclosure form 802 includes an intelligent summary section that synthesizes a concise overview of essential elements from multiple submissions, providing inventors with an at-a-glance understanding of their disclosure documents' content and relevance without manually aggregating information. The AI-generated disclosure form 802 also includes a title area: This segment displays the name or title assigned to each AI-generated form, ensuring clear identification and organization within Display 800 for easy referencing by inventors or users. The AI-generated disclosure form 802 also includes an automated status indicator that reflects the current stage of the disclosure process, such as “Pending Review,” “Under Examination,” or “Accepted,” based on real-time data from inventors, portfolio managers, drafting attorney, the USPTO and other relevant institutions. The AI-generated disclosure form 802 also includes a submission date field, an automatically populated field that records when each AI-generated form was created (or the earliest submission document was received), allowing inventors to track their submission timeline accurately. The AI-generated disclosure form 802 also includes AI-generated tags. The algorithmically assigned categorization labels help inventors navigate through disclosures efficiently by grouping related documents based on shared characteristics or themes. The AI-generated disclosure form 802 also includes a predicted USPTO classification (802). This intelligently predicted section forecasts each AI-generated form's potential United States Patent and Trademark Office (USPTO) classifications. The AI-generated disclosure form 802 also includes a generated problem and solution text. An innovative feature that identifies potential issues or inconsistencies in the AI-generated form based on historical data and suggests actionable solutions to inventors for preemptive correction, thus enhancing the quality of submissions before they are finalized.

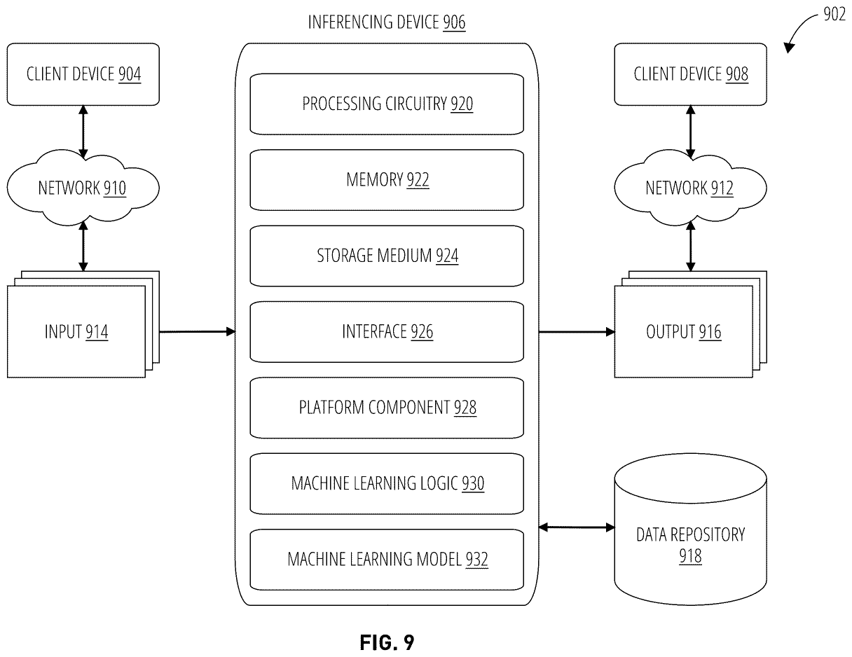

FIG. 9 illustrates an embodiment of a system 902. The example system architecture, illustrated in relation to system 902, comprises one or more client devices, an inferencing device, and a data repository interconnected via one or more networks, suitable for implementing AI-based disclosure generation and access-controlled data presentation The system 902 is suitable for implementing one or more embodiments as described herein. In one embodiment, for example, the system 902 is an AI/ML system suitable for performing invention discovery and/or form feedback during invention disclosure form generation.

The system 902 comprises a set of M devices, where M is any positive integer. FIG. 9 depicts three devices (M=3), including a client device 904, an inferencing device 906, and a client device 908. The inferencing device 906 communicates information with the client device 904 and the client device 908 over a network 910 and a network 912, respectively. The information may include input 914 from the client device 904 and output 916 to the client device 908, or vice-versa. In one alternative, the input 914 and the output 916 are communicated between the same client device 904 or client device 908. In another alternative, the input 914 and the output 916 are stored in a data repository 918. In yet another alternative, the input 914 and the output 916 are communicated via a platform component 928 of the inferencing device 906, such as an input/output (I/O) device (e.g., a touchscreen, a microphone, a speaker, etc.).

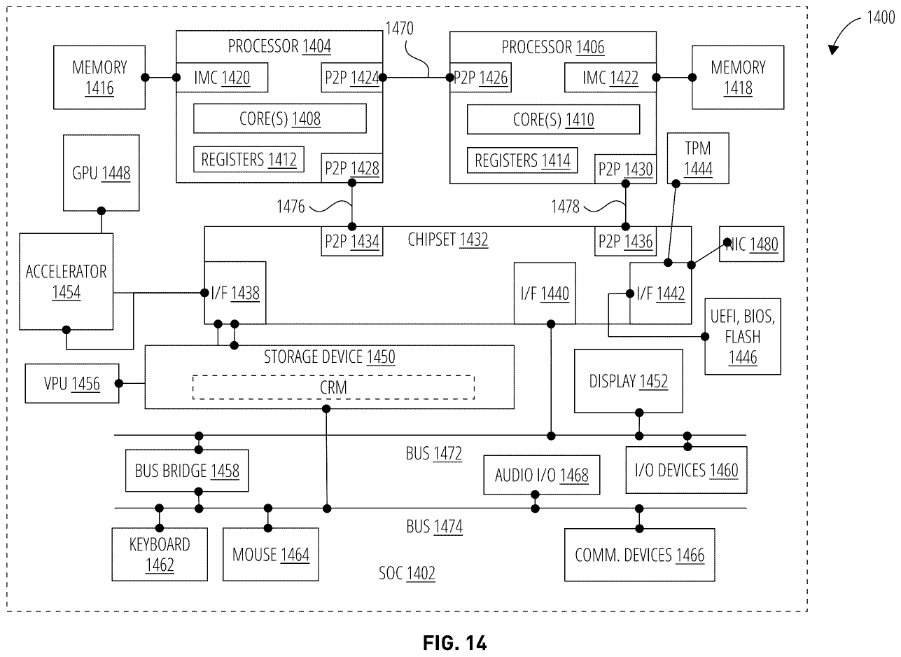

As depicted in FIG. 9, the inferencing device 906 includes processing circuitry 920, a memory 922, a storage medium 924, an interface 926, a platform component 928, ML logic 930, and an ML model 932. In some implementations, the inferencing device 906 includes other components or devices as well. Examples for software elements and hardware elements of the inferencing device 906 are described in more detail with reference to a computing architecture 1400 as depicted in FIG. 14. Embodiments are not limited to these examples.

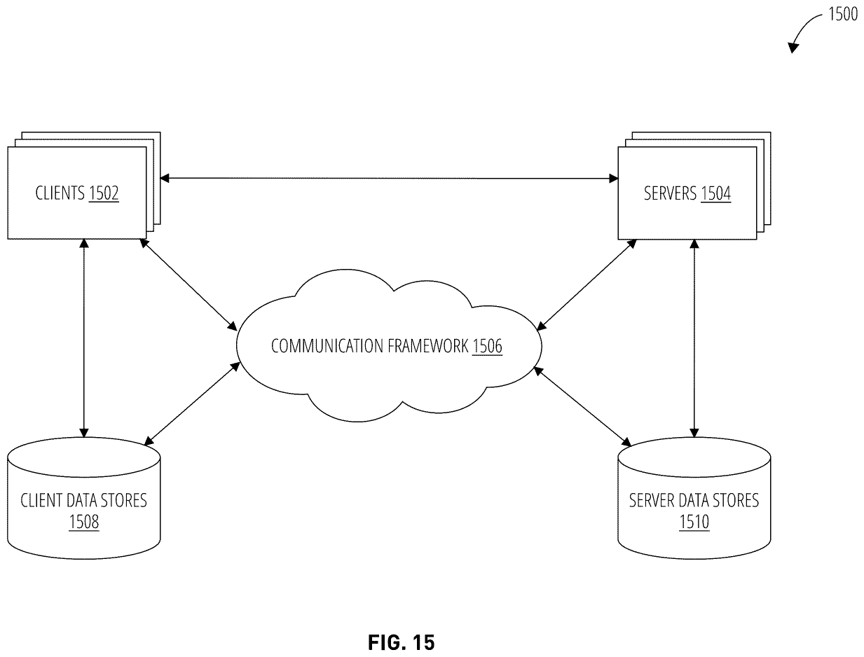

The inferencing device 906 is generally arranged to receive an input 914, process the input 914 via one or more AI/ML techniques, and send an output 916. The inferencing device 906 receives the input 914 from the client device 904 via the network 910, the client device 908 via the network 912, the platform component 928 (e.g., a touchscreen as a text command or microphone as a voice command), the memory 922, the storage medium 924 or the data repository 918. The inferencing device 906 sends the output 916 to the client device 904 via the network 910, the client device 908 via the network 912, the platform component 928 (e.g., a touchscreen to present text, graphic or video information or speaker to reproduce audio information), the memory 922, the storage medium 924 or the data repository 918. Examples for the software elements and hardware elements of the network 910 and the network 912 are described in more detail with reference to a communications architecture 1500 as depicted in FIG. 15. Embodiments are not limited to these examples.

The inferencing device 906 includes ML logic 930 and an ML model 932 to implement various AI/ML techniques for various AI/ML tasks. The ML logic 930 receives the input 914, and processes the input 914 using the ML model 932. The ML model 932 performs inferencing operations to generate an inference for a specific task from the input 914. In some cases, the inference is part of the output 916. The output 916 is used by the client device 904, the inferencing device 906, or the client device 908 to perform subsequent actions in response to the output 916.

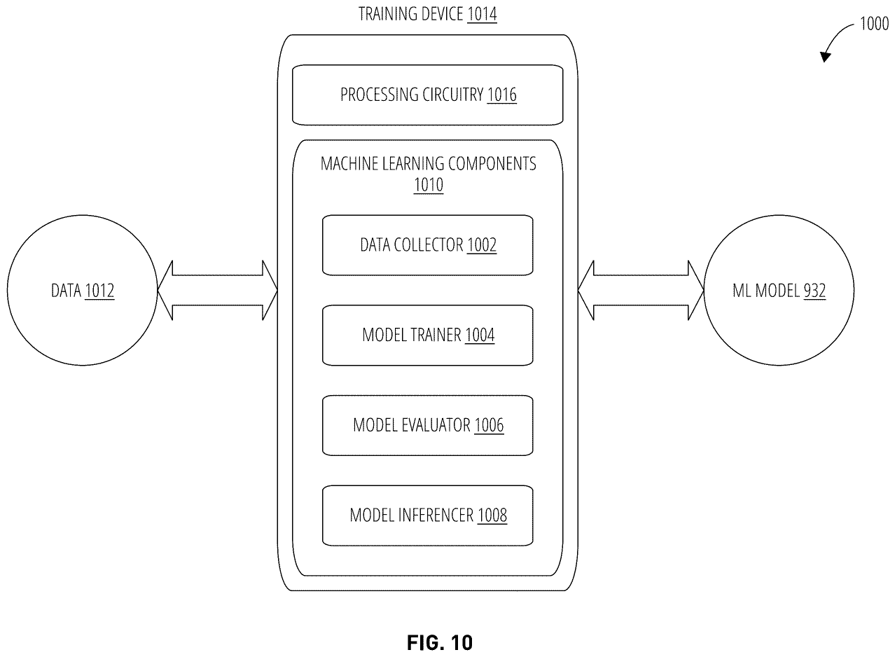

In various embodiments, the ML model 932 is a trained ML model 932 using a set of training operations. An example of training operations to train the ML model 932 is described with reference to FIG. 10.

FIG. 10 illustrates an apparatus 1000. The apparatus 1000 depicts a training device 1014 suitable to generate a trained ML model 932 for the inferencing device 906 of the system 902. As depicted in FIG. 10, the training device 1014 includes a processing circuitry 1016 and a set of ML components 1010 to support various AI/ML techniques, such as a data collector 1002, a model trainer 1004, a model evaluator 1006 and a model inferencer 1008.

In general, the data collector 1002 collects data 1012 from one or more data sources (prior art systems) to use as training data for the ML model 932. The data collector 1002 collects different types of data 1012, such as text information, audio information, image information, video information, graphic information, and so forth, for example. The model trainer 1004 receives as input the collected data and uses a portion of the collected data as test data for an AI/ML algorithm to train the ML model 932. The model evaluator 1006 evaluates and improves the trained ML model 932 using a portion of the collected data as test data to test the ML model 932. The model evaluator 1006 also uses feedback information from the deployed ML model 932. The model inferencer 1008 implements the trained ML model 932 to receive as input new unseen data, generate one or more inferences on the new data, and output a result such as an alert, a recommendation or other post-solution activity.

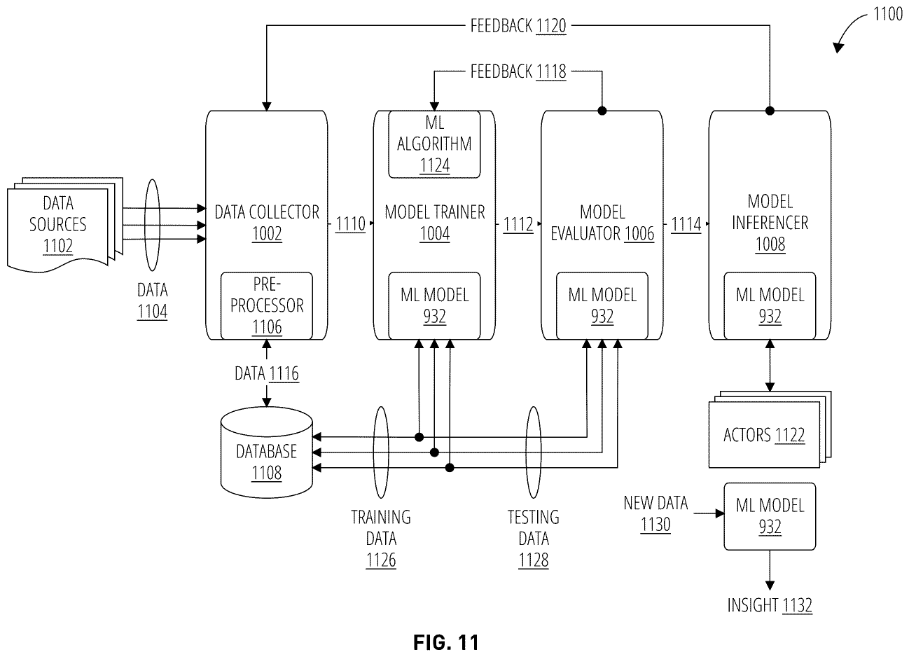

An exemplary AI/ML architecture for the ML components 1010 is described in more detail with reference to FIG. 11.

FIG. 11 illustrates an artificial intelligence architecture 1100 suitable for use by the training device 1014 to generate the ML model 932 for deployment by the inferencing device 906. The artificial intelligence architecture 1100 is an example of a system suitable for implementing various AI techniques and/or ML techniques to perform various inferencing tasks on behalf of the various devices of the system 902.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1100 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 932, evaluate performance of the trained ML model 932, and deploy the tested ML model 932 as the trained ML model 932 in a production environment, and continuously monitor and maintain it.

The ML model 932 is a mathematical construct used to predict outcomes based on a set of input data. The ML model 932 is trained using large volumes of training data 1126 (prior art), and it can recognize patterns and trends in the training data 1126 to make accurate predictions. The ML model 932 is derived from an ML algorithm 1124 (e.g., a neural network, decision tree, support vector machine, etc.). A data set is fed into the ML algorithm 1124 which trains an ML model 932 to “learn” a function that produces mappings between a set of inputs and a set of outputs with a reasonably high accuracy. Given a sufficiently large enough set of inputs and outputs, the ML algorithm 1124 finds the function for a given task. This function may even be able to produce the correct output for input that it has not seen during training. A data scientist prepares the mappings, selects and tunes the ML algorithm 1124, and evaluates the resulting model performance. Once the ML logic 930 is sufficiently accurate on test data, it can be deployed for production use.

The ML algorithm 1124 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1124 of the artificial intelligence architecture 1100 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 11, the artificial intelligence architecture 1100 includes a set of data sources 1102 to source data 1104 for the artificial intelligence architecture 1100. Data sources 1102 may comprise any device capable generating, processing, storing or managing data 1104 suitable for a ML system. Examples of data sources 1102 include without limitation databases, web scraping, sensors and Internet of Things (IoT) devices, image and video cameras, audio devices, text generators, publicly available databases, private databases, and many other data sources 1102. The data sources 1102 may be remote from the artificial intelligence architecture 1100 and accessed via a network, local to the artificial intelligence architecture 1100 an accessed via a network interface, or may be a combination of local and remote data sources 1102.

The data sources 1102 source difference types of data 1104. By way of example and not limitation, the data 1104 includes structured data from relational databases, such as customer profiles, transaction histories, or product inventories. The data 1104 includes unstructured data from websites such as customer reviews, news articles, social media posts, or product specifications. The data 1104 includes data from temperature sensors, motion detectors, and smart home appliances. The data 1104 includes image data from medical images, security footage, or satellite images. The data 1104 includes audio data from speech recognition, music recognition, or call centers. The data 1104 includes text data from emails, chat logs, customer feedback, news articles or social media posts. The data 1104 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1104 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1102 are communicatively coupled to a data collector 1002. The data collector 1002 gathers relevant data 1104 from the data sources 1102. Once collected, the data collector 1002 may use a pre-processor 1106 to make the data 1104 suitable for analysis. This involves data cleaning, transformation, and feature engineering. Data preprocessing is a critical step in ML as it directly impacts the accuracy and effectiveness of the ML model 932. The pre-processor 1106 receives the data 1104 as input, processes the data 1104, and outputs pre-processed data 1116 for storage in a database 1108. Examples for the database 1108 includes a hard drive, solid state storage, and/or random access memory (RAM).

The data collector 1002 is communicatively coupled to a model trainer 1004. The model trainer 1004 performs AI/ML model training, validation, and testing which may generate model performance metrics as part of the model testing procedure. The model trainer 1004 receives the pre-processed data 1116 as input 1110 or via the database 1108. The model trainer 1004 implements a suitable ML algorithm 1124 to train an ML model 932 on a set of training data 1126 from the pre-processed data 1116. The training process involves feeding the pre-processed data 1116 into the ML algorithm 1124 to produce or optimize an ML model 932. The training process adjusts its parameters until it achieves an initial level of satisfactory performance.

The model trainer 1004 is communicatively coupled to a model evaluator 1006. After an ML model 932 is trained, the ML model 932 needs to be evaluated to assess its performance. This is done using various metrics such as accuracy, precision, recall, and F1 score. The model trainer 1004 outputs the ML model 932, which is received as input 1110 or from the database 1108. The model evaluator 1006 receives the ML model 932 as input 1112, and it initiates an evaluation process to measure performance of the ML model 932. The evaluation process includes providing feedback 1118 to the model trainer 1004. The model trainer 1004 re-trains the ML model 932 to improve performance in an iterative manner.

The model evaluator 1006 is communicatively coupled to a model inferencer 1008. The model inferencer 1008 provides AI/ML model inference output (e.g., inferences, predictions or decisions). Once the ML model 932 is trained and evaluated, it is deployed in a production environment where it is used to make predictions on new data. The model inferencer 1008 receives the evaluated ML model 932 as input 1114. The model inferencer 1008 uses the evaluated ML model 932 to produce insights or predictions on real data, which is deployed as a final production ML model 932. The inference output of the ML model 932 is use case specific. The model inferencer 1008 also performs model monitoring and maintenance, which involves continuously monitoring performance of the ML model 932 in the production environment and making any necessary updates or modifications to maintain its accuracy and effectiveness. The model inferencer 1008 provides feedback 1118 to the data collector 1002 to train or re-train the ML model 932. The feedback 1118 includes model performance feedback information, which is used for monitoring and improving performance of the ML model 932.

Some or all of the model inferencer 1008 is implemented by various actors 1122 in the artificial intelligence architecture 1100, including the ML model 932 of the inferencing device 906, for example. The actors 1122 use the deployed ML model 932 on new data to make inferences or predictions for a given task, and output an insight 1132. The actors 1122 implement the model inferencer 1008 locally, or remotely receives outputs from the model inferencer 1008 in a distributed computing manner. The actors 1122 trigger actions directed to other entities or to itself. The actors 1122 provide feedback 1120 to the data collector 1002 via the model inferencer 1008. The feedback 1120 comprise data needed to derive training data, inference data or to monitor the performance of the ML model 932 and its impact to the network through updating of key performance indicators (KPIs) and performance counters.

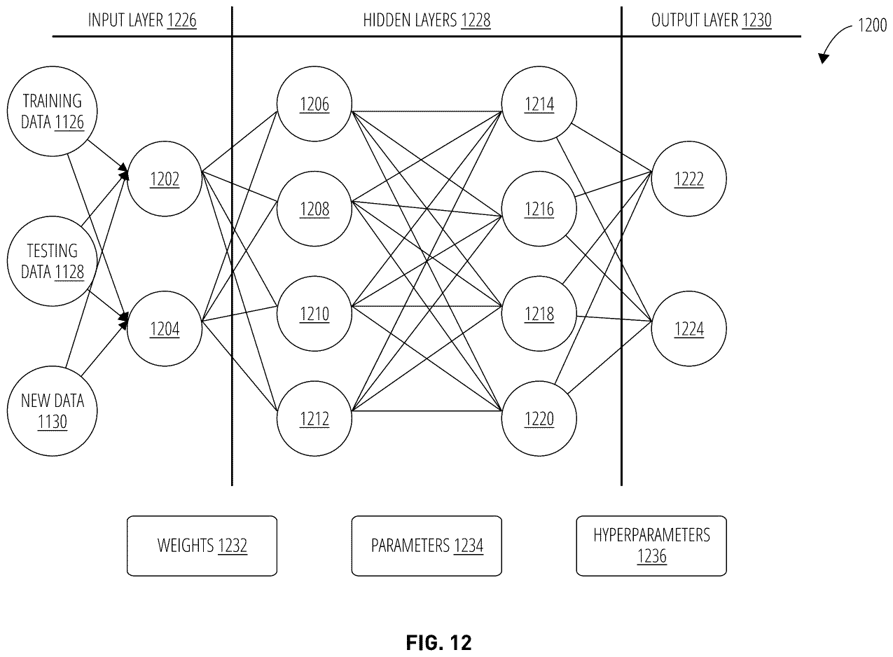

As previously described with reference to FIGS. 1, 2, the systems 902, 1000 implement some or all of the artificial intelligence architecture 1100 to support various use cases and solutions for various AI/ML tasks. In various embodiments, the training device 1014 of the apparatus 1000 uses the artificial intelligence architecture 1100 to generate and train the ML model 932 for use by the inferencing device 906 for the system 902. In one embodiment, for example, the training device 1014 may train the ML model 932 as a neural network, as described in more detail with reference to FIG. 12. Other use cases and solutions for AI/ML are possible as well, and embodiments are not limited in this context.

FIG. 12 illustrates an embodiment of an artificial neural network 1200. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1200 comprises multiple node layers, containing an input layer 1226, one or more hidden layers 1228, and an output layer 1230. Each layer comprises one or more nodes, such as nodes 1202 to 1224. As depicted in FIG. 12, for example, the input layer 1226 has nodes 1202, 1204. The artificial neural network 1200 has two hidden layers 1228, with a first hidden layer having nodes 1206, 1208, 1210 and 1212, and a second hidden layer having nodes 1214, 1216, 1218 and 1220. The artificial neural network 1200 has an output layer 1230 with nodes 1222, 1224. Each node 1202 to 1224 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1200 relies on training data 1126 to learn and improve accuracy over time. However, once the artificial neural network 1200 is fine-tuned for accuracy, and tested on testing data 1128, the artificial neural network 1200 is ready to classify and cluster new data 1130 at a high velocity. Tasks in speech recognition or image recognition can take minutes versus hours when compared to the manual identification by human experts.

Each individual node 1202 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias output = f ( x ) = 1 if \sum w 1 x 1 + b >= 0 ; \\ 0 if \sum w 1 x 1 + b < 0 \qquad EQUATION ( 1 )$$

Once an input layer 1226 is determined, a set of weights 1234 are assigned. The weights 1234 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1200 as a feedforward network.

In one embodiment, the artificial neural network 1200 leverages sigmoid neurons, which are distinguished by having values between 0 and 1. Since the artificial neural network 1200 behaves similarly to a decision tree, cascading data from one node to another, having x values between 0 and 1 will reduce the impact of any given change of a single variable on the output of any given node, and subsequently, the output of the artificial neural network 1200.

The artificial neural network 1200 has many practical use cases, like image recognition, speech recognition, text recognition or classification. The artificial neural network 1200 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = M S E = \frac{1}{2 m} {\sum }_{i = 1}^{m} {( {\hat{y}}_{i} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1234 of the model adjust to gradually converge at the minimum.

In one embodiment, the artificial neural network 1200 is feedforward, meaning it flows in one direction only, from input to output. In one embodiment, the artificial neural network 1200 uses backpropagation. Backpropagation is when the artificial neural network 1200 moves in the opposite direction from output to input. Backpropagation allows calculation and attribution of errors associated with each neuron 1202 to 1224, thereby allowing adjustment to fit the parameters 1234 of the ML model 932 appropriately.

The artificial neural network 1200 is implemented as different neural networks depending on a given task. Neural networks are classified into different types, which are used for different purposes. In one embodiment, the artificial neural network 1200 is implemented as a feedforward neural network, or multi-layer perceptrons (MLPs), comprised of an input layer 1226, hidden layers 1228, and an output layer 1230. While these neural networks are also commonly referred to as MLPs, they are actually comprised of sigmoid neurons, not perceptrons, as most real-world problems are nonlinear. Trained data 1104 usually is fed into these models to train them, and they are the foundation for computer vision, natural language processing, and other neural networks. In one embodiment, the artificial neural network 1200 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1200 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1200 is implemented as any type of neural network suitable for a given operational task of system 902, and the MLP, CNN, and RNN are merely a few examples. Embodiments are not limited in this context.

The artificial neural network 1200 includes a set of associated parameters 1234. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1200 is implemented as a deep learning neural network. The term deep learning neural network refers to a depth of layers in a given neural network. A neural network that has more than three layers-which would be inclusive of the inputs and the output—can be considered a deep learning algorithm. A neural network that only has two or three layers, however, may be referred to as a basic neural network. A deep learning neural network may tune and optimize one or more hyperparameters 1236. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

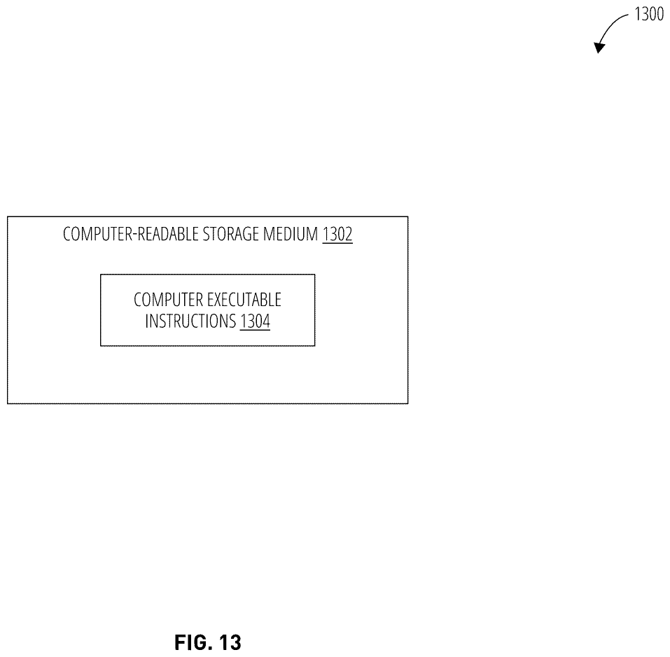

FIG. 13 illustrates an apparatus 1300. Apparatus 1300 comprises any non-transitory computer-readable storage medium 1302 or machine-readable storage medium, such as an optical, magnetic or semiconductor storage medium. In various embodiments, apparatus 1300 comprises an article of manufacture or a product. In some embodiments, the computer-readable storage medium 1302 stores computer executable instructions with which one or more processing devices or processing circuitry can execute. For example, computer executable instructions 1304 includes instructions to implement operations described with respect to any logic flows described herein. Examples of computer-readable storage medium 1302 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1304 include any suitable type of code, such as source code, compiled code, interpreted code, executable code, static code, dynamic code, object-oriented code, visual code, and the like.

FIG. 14 illustrates an embodiment of a computing architecture 1400. Computing architecture 1400 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1400 has a single processor with one core or more than one processor. Note that the term “processor” refers to a processor with a single core or a processor package with multiple processor cores. In at least one embodiment, the computing computing architecture 1400 is representative of the components of the system 902. More generally, the computing computing architecture 1400 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1400. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 14, computing architecture 1400 comprises a system-on-chip (SoC) 1402 for mounting platform components. System-on-chip (SoC) 1402 is a point-to-point (P2P) interconnect platform that includes a first processor 1404 and a second processor 1406 coupled via a point-to-point interconnect 1470 such as an Ultra Path Interconnect (UPI). In other embodiments, the computing architecture 1400 is another bus architecture, such as a multi-drop bus. Furthermore, each of processor 1404 and processor 1406 are processor packages with multiple processor cores including core(s) 1408 and core(s) 1410, respectively. While the computing architecture 1400 is an example of a two-socket (2 S) platform, other embodiments include more than two sockets or one socket. For example, some embodiments include a four-socket (4 S) platform or an eight-socket (8 S) platform. Each socket is a mount for a processor and may have a socket identifier. Note that the term platform refers to a motherboard with certain components mounted such as the processor 1404 and chipset 1432. Some platforms include additional components and some platforms include sockets to mount the processors and/or the chipset. Furthermore, some platforms do not have sockets (e.g. SoC, or the like). Although depicted as a SoC 1402, one or more of the components of the SoC 1402 are included in a single die package, a multi-chip module (MCM), a multi-die package, a chiplet, a bridge, and/or an interposer. Therefore, embodiments are not limited to a SoC.

The processor 1404 and processor 1406 are any commercially available processors, including without limitation an Intel® Celeron®, Core®, Core (2) Duo®, Itanium®, Pentium®, Xcon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1404 and/or processor 1406. Additionally, the processor 1404 need not be identical to processor 1406.

Processor 1404 includes an integrated memory controller (IMC) 1420 and point-to-point (P2P) interface 1424 and P2P interface 1428. Similarly, the processor 1406 includes an IMC 1422 as well as P2P interface 1426 and P2P interface 1430. IMC 1420 and IMC 1422 couple the processor 1404 and processor 1406, respectively, to respective memories (e.g., memory 1416 and memory 1418). Memory 1416 and memory 1418 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1416 and the memory 1418 locally attach to the respective processors (i.e., processor 1404 and processor 1406). In other embodiments, the main memory couple with the processors via a bus and shared memory hub. Processor 1404 includes registers 1412 and processor 1406 includes registers 1414.

Computing architecture 1400 includes chipset 1432 coupled to processor 1404 and processor 1406. Furthermore, chipset 1432 are coupled to storage device 1450, for example, via an interface (I/F) 1438. The I/F 1438 may be, for example, a Peripheral Component Interconnect-enhanced (PCIe) interface, a Compute Express Link® (CXL) interface, or a Universal Chiplet Interconnect Express (UCIe) interface. Storage device 1450 stores instructions executable by circuitry of computing architecture 1400 (e.g., processor 1404, processor 1406, GPU 1448, accelerator 1454, vision processing unit 1456, or the like). For example, storage device 1450 can store instructions for the client device 904, the client device 908, the inferencing device 906, the training device 1014, or the like.

Processor 1404 couples to the chipset 1432 via P2P interface 1428 and P2P 1434 while processor 1406 couples to the chipset 1432 via P2P interface 1430 and P2P 1436. Direct media interface (DMI) 1476 and DMI 1478 couple the P2P interface 1428 and the P2P 1434 and the P2P interface 1430 and P2P 1436, respectively. DMI 1476 and DMI 1478 is a high-speed interconnect that facilitates, e.g., eight Giga Transfers per second (GT/s) such as DMI 3.0. In other embodiments, the processor 1404 and processor 1406 interconnect via a bus.

The chipset 1432 comprises a controller hub such as a platform controller hub (PCH). The chipset 1432 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1432 comprises more than one controller hub such as a chipset with a memory controller hub, a graphics controller hub, and an input/output (I/O) controller hub.

In the depicted example, chipset 1432 couples with a trusted platform module (TPM) 1444 and UEFI, BIOS, FLASH circuitry 1446 via I/F 1442. The TPM 1444 is a dedicated microcontroller designed to secure hardware by integrating cryptographic keys into devices. The UEFI, BIOS, FLASH circuitry 1446 may provide pre-boot code. The I/F 1442 may also be coupled to a network interface circuit (NIC) 1480 for connections off-chip.

Furthermore, chipset 1432 includes the I/F 1438 to couple chipset 1432 with a high-performance graphics engine, such as, graphics processing circuitry or a graphics processing unit (GPU) 1448. In other embodiments, the computing architecture 1400 includes a flexible display interface (FDI) (not shown) between the processor 1404 and/or the processor 1406 and the chipset 1432. The FDI interconnects a graphics processor core in one or more of processor 1404 and/or processor 1406 with the chipset 1432.

The computing architecture 1400 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1454 and/or vision processing unit 1456 are coupled to chipset 1432 via I/F 1438. The accelerator 1454 is representative of any type of accelerator device (e.g., a data streaming accelerator, cryptographic accelerator, cryptographic co-processor, an offload engine, etc.). One example of an accelerator 1454 is the Intel® Data Streaming Accelerator (DSA). The accelerator 1454 is a device including circuitry to accelerate copy operations, data encryption, hash value computation, data comparison operations (including comparison of data in memory 1416 and/or memory 1418), and/or data compression. Examples for the accelerator 1454 include a USB device, PCI device, PCIe device, CXL device, UCIe device, and/or an SPI device. The accelerator 1454 also includes circuitry arranged to execute machine learning (ML) related operations (e.g., training, inference, etc.) for ML models. Generally, the accelerator 1454 is specially designed to perform computationally intensive operations, such as hash value computations, comparison operations, cryptographic operations, and/or compression operations, in a manner that is more efficient than when performed by the processor 1404 or processor 1406. Because the load of the computing architecture 1400 includes hash value computations, comparison operations, cryptographic operations, and/or compression operations, the accelerator 1454 greatly increases performance of the computing architecture 1400 for these operations.

The accelerator 1454 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1454. For example, the accelerator 1454 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1454 via a non-posted write (e.g., a deferred memory write (DMWr)). One example of an instruction that atomically submits a work descriptor to the shared work queue of the accelerator 1454 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1454. The dedicated work queue may accept job submissions via commands such as the movdir64b instruction.

Various I/O devices 1460 and display 1452 couple to the bus 1472, along with a bus bridge 1458 which couples the bus 1472 to a second bus 1474 and an I/F 1440 that connects the bus 1472 with the chipset 1432. In one embodiment, the second bus 1474 is a low pin count (LPC) bus. Various input/output (I/O) devices couple to the second bus 1474 including, for example, a keyboard 1462, a mouse 1464 and communication devices 1466.

Furthermore, an audio I/O 1468 couples to second bus 1474. Many of the I/O devices 1460 and communication devices 1466 reside on the system-on-chip (SoC) 1402 while the keyboard 1462 and the mouse 1464 are add-on peripherals. In other embodiments, some or all the I/O devices 1460 and communication devices 1466 are add-on peripherals and do not reside on the system-on-chip (SoC) 1402.

FIG. 15 illustrates a block diagram of an exemplary communications architecture 1500 suitable for implementing various embodiments as previously described. The communications architecture 1500 includes various common communications elements, such as a transmitter, receiver, transceiver, radio, network interface, baseband processor, antenna, amplifiers, filters, power supplies, and so forth. The embodiments, however, are not limited to implementation by the communications architecture 1500.

As shown in FIG. 15, the communications architecture 1500 includes one or more clients 1502 and servers 1504. The clients 1502 and the servers 1504 are operatively connected to one or more respective client data stores 1508 and server data stores 1510 that can be employed to store information local to the respective clients 1502 and servers 1504, such as cookies and/or associated contextual information.

The clients 1502 and the servers 1504 communicate information between each other using a communication framework 1506. The communication framework 1506 implements any well-known communications techniques and protocols. The communication framework 1506 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1506 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/902/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1502 and the servers 1504. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Aspects of the present disclosure are directed to a computer-implemented method comprising: receiving, by a system, a submission of an idea; comparing the submission to stored submissions using a similarity metric to determine whether the submission represents a new idea or a version of an existing idea; storing, in a data store, metadata for the submission including a contributor identifier, a unique idea identifier, and an access level, and recording a relationship between the submission and one or more related submissions; responsive to a user request to view data for the idea, determining an access level of the user and a submission access level for each related submission; selecting a subset of the related submissions permitted for the user; generating, using generative artificial intelligence, a content package comprising a synthesized summary and disclosure fields from the selected submissions; and presenting the content package in a graphical user interface (GUI). Wherein, in some examples, the generative artificial intelligence is configured to redact confidential or restricted fields before inclusion in the content package)—(wherein the similarity metric comprises an embedding-space distance with a threshold for linking submissions as versions of a same idea.

In some embodiments, receiving the submission of an idea comprises, extracting a plurality of idea objects from one or more of one or more source documents retrieved from a document source and one or more user idea submissions provided via a submission API, the idea objects comprising one or more canonical text records and one or more document source references, wherein comparing the submission to stored submissions comprises computing similarities between the idea objects. Wherein submissions are received via multi-format inputs including text, audio, images, and documents. In some embodiments determining the access level of the user and the submission access level for each related submission are derived from the one or more source documents.

In some embodiments, the computer-implemented method, further comprising computing a uniqueness score for an idea object as a function of a density of embeddings within K-nearest neighbors. In some embodiments recording a relationship between the submission and one or more related submissions comprises, creating, based on the similarities and a decision policy, one or more relational links associated with the idea object, the one or more relational links comprising at least one of an equivalence relational link, a succession relational link, or a merge to yield a versioned idea object. The decision policy considers a temporal precedence and one or more semantic refinement features to prefer a succession relational link over an equivalence relational link. Wherein versions of the same idea are displayed in chronological order within the graphical user interface.

In some embodiments, the computer-implemented method, further comprising, persisting the idea objects and the one or more relational links in an idea graph with one or more provenance data records associated with each idea object, wherein the idea graph comprises a subgraph representing one or more version chains associated with the at least one succession relational link and a subgraph representing the at least one equivalence relational link. The computer-implemented method further may further comprise computing a projection of the idea graph conditioned on the access level of the user and a submission access level for each related submission. In some embodiments, the computer-implemented method, may further comprise synthesizing, from the projection, a disclosure document that includes only content authorized for the requesting user, wherein synthesizing the disclosure document comprises mapping selected idea objects to patent specification sections and rendering structured text templates.

In some embodiments, the computer-implemented method, may further comprise performing a tag-assisted prefiltering operation prior to using the similarity metric for performing an embedding similarity computation (wherein computing similarity correspond to a similarity metric comprising one or more of cosine similarity, Euclidean distance, or semantic embedding vectors). The method may further comprise selecting, by a compute-budget controller, between the embedding similarity (matching) computation and the tag-assisted matching responsive to resource constraints.

One aspect of the present disclosure is directed to a system comprising: one or more processors and a memory storing instructions which, when executed, cause the one or more processors to: ingest text from a plurality of sources, the plurality of source references comprising one or more of at least a reference document and at least a user submission received, via a submission API, form one or more users; extract, from the ingested text and the one or more user submissions, a plurality of idea objects, each idea object comprising canonical [normalized] text and one or more source references; compute similarities between pairs of the idea objects; (wherein the similarity metric comprises an embedding-space distance with a threshold for linking submissions as versions of a same idea) based on the computed similarities and at least one decision policy, create one or more relational links between the idea objects, wherein the relational links comprise one or more of: an equivalence relational link, a succession relational link, or a merge of two or more idea objects into a versioned idea object; persist the idea objects and the one or more relational links in an idea graph that records provenance of merged idea objects; evaluate access permissions of a requesting user with respect to the plurality of source references; compute, from the idea graph and the access permissions, a projection that is a user-specific permutation of the idea graph comprising only content visible to the requesting principal; and generate, from the projection, a disclosure document comprising sections synthesized from idea objects included in the projection. In some examples, the access permissions may be derived from per-source access control lists and attribute-based policies.

In some embodiments, the projection that is a user-specific permutation of the idea graph is initiated in response to receiving, by the system, an input to generate a disclosure form—wherein applying a generative artificial intelligence model to the data of the one or more submissions to generate the disclosure form, the disclosure form comprising an AI-generated summary, predicted patent classification, and problem-and-solution text—wherein the content is filtered for inclusion in the disclosure form based on the access level of the user and access level of the submissions. (wherein a disclosure form is generated with selectable fields for inclusion based on user choice or automated relevance ranking). In some examples, the computing similarities between pairs of the idea objects comprises computing similarity between a received idea submission and one or more stored idea submissions to assign the idea submission to one of (i) a new idea or (ii) an existing idea version, wherein the system further comprises a training module configured to refine similarity thresholds based on user feedback.

In some embodiments, the system stores the idea objects in context of a governed data schema which includes one or more submission metadata, the one or more submission metadata comprising one or more of a contributor identifier, unique idea identifier, access levels, and links to one or more source references. Wherein the governed data schema stores submission provenance data including submission channel, date, file type, and contributor profile.

In some embodiments, the one or more processors of the system may be further configured to: enforce a role-based access control to restrict visibility of submissions; and automatically generate, in response to a portfolio action, an inventor disclosure document using data from one or more authorized submissions. (wherein the role-based access control enforces both user-level and submission-level restrictions before displaying any submission data). In some examples, the merge creates a versioned idea object and updates pointers from antecedent idea objects to the versioned idea object while retaining a provenance ledger. The decision policy may adapt thresholds for equivalence and succession based on feedback signals.

In some embodiments, the one or more processors are further configured to compute a uniqueness value for an idea object based on a density of embeddings of neighboring idea objects within an organization corpus. In some examples the system may be further configured to perform tag-assisted matching that filters candidate pairs prior to computing embedding-based similarities. In some examples, the one or more processors may be further configured to annotate one or more succession edges with semantic deltas indicating constraints added or broadened between versions of an idea object. The system may further comprise an interface rendering a portfolio-level view that surfaces merged organization-wide versions and an inventor-level view that surfaces user-submitted versions (wherein the access control is hierarchical such that higher-level roles can view submissions at their level and all lower levels). In some examples, a one-click portfolio workflow consolidates multiple versions of an idea object into a single disclosure document.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

1. A computer-implemented method comprising:
receiving, by a system, a submission of an idea;
comparing the submission to stored submissions using a similarity metric to determine whether the submission represents a new idea or a version of an existing idea;
storing, in a data store, metadata for the submission including a contributor identifier, a unique idea identifier, and an access level, and recording a relationship between the submission and one or more related submissions;
responsive to a user request to view data for the idea, determining an access level of the user and a submission access level for each related submission;
selecting a subset of the related submissions permitted for the user;
generating, using generative artificial intelligence, a content package comprising a synthesized summary and disclosure fields from the selected submissions; and
presenting the content package in a graphical user interface (GUI).

2. The computer-implemented method of claim 1, wherein receiving the submission of an idea comprises, extracting a plurality of idea objects from one or more of one or more source documents retrieved from a document source and one or more user idea submissions provided via a submission API, the idea objects comprising one or more canonical text records and one or more document source references, wherein comparing the submission to stored submissions comprises computing similarities between the idea objects.

3. The computer-implemented method of claim 2, wherein determining the access level of the user and the submission access level for each related submission are derived from the one or more source documents.

4. The computer-implemented method of claim 2, further comprising computing a uniqueness score for an idea object as a function of a density of embeddings within K-nearest neighbors.

5. The computer-implemented method of claim 2, wherein recording a relationship between the submission and one or more related submissions comprises, creating, based on the similarities and a decision policy, one or more relational links associated with the idea object, the one or more relational links comprising at least one of an equivalence relational link, a succession relational link, or a merge to yield a versioned idea object.

6. The computer-implemented method of claim 5, wherein the decision policy considers a temporal precedence and one or more semantic refinement features to prefer a succession relational link over an equivalence relational link.

7. The computer-implemented method of claim 5, further comprising, persisting the idea objects and the one or more relational links in an idea graph with one or more provenance data records associated with each idea object.

8. The computer-implemented method of claim 7, wherein the idea graph comprises a subgraph representing one or more version chains associated with the at least one succession relational link and a subgraph representing the at least one equivalence relational link.

8. The computer-implemented method of claim 7, further comprising computing a projection of the idea graph conditioned on the access level of the user and a submission access level for each related submission.

9. The computer-implemented method of claim 8, further comprising synthesizing, from the projection, a disclosure document that includes only content authorized for the requesting user, wherein synthesizing the disclosure document comprises mapping selected idea objects to patent specification sections and rendering structured text templates.

10. The computer-implemented method of claim 1, further comprising performing a tag-assisted prefiltering operation prior to using the similarity metric for performing an embedding similarity computation.

11. The computer-implemented method of claim 10, further comprising selecting, by a compute-budget controller, between the embedding similarity (matching) computation and the tag-assisted matching responsive to resource constraints.

12. A system comprising: one or more processors and a memory storing instructions which, when executed, cause the one or more processors to:
ingest text from a plurality of sources, the plurality of source references comprising one or more of at least a reference document and at least a user submission received, via a submission API, form one or more users;
extract, from the ingested text and the one or more user submissions, a plurality of idea objects, each idea object comprising canonical [normalized] text and one or more source references;
compute similarities between pairs of the idea objects; (wherein the similarity metric comprises an embedding-space distance with a threshold for linking submissions as versions of a same idea)
based on the computed similarities and at least one decision policy, create one or more relational links between the idea objects, wherein the relational links comprise one or more of: an equivalence relational link, a succession relational link, or a merge of two or more idea objects into a versioned idea object;
persist the idea objects and the one or more relational links in an idea graph that records provenance of merged idea objects;
evaluate access permissions of a requesting user with respect to the plurality of source references;
compute, from the idea graph and the access permissions, a projection that is a user-specific permutation of the idea graph comprising only content visible to the requesting principal; and
generate, from the projection, a disclosure document comprising sections synthesized from idea objects included in the projection.

13. The system of claim 12, wherein computing similarities between pairs of the idea objects comprises computing similarity between a received idea submission and one or more stored idea submissions to assign the idea submission to one of (i) a new idea or (ii) an existing idea version.

14. The system of claim 12, where in the idea objects are stored in a governed data schema which includes one or more submission metadata, the one or more submission metadata comprising one or more of a contributor identifier, unique idea identifier, access levels, and links to one or more source references.

15. The system of claim 12, wherein the one or more processors are configured to:
enforce a role-based access control to restrict visibility of submissions; and
automatically generate, in response to a portfolio action, an inventor disclosure document using data from one or more authorized submissions.

16. The system of claim 12, wherein the merge creates a versioned idea object and updates pointers from antecedent idea objects to the versioned idea object while retaining a provenance ledger.

17. The system of claim 12, wherein the decision policy adapts thresholds for equivalence and succession based on feedback signals.

18. The system of claim 12, wherein the one or more processors are further configured to compute a uniqueness value for an idea object based on a density of embeddings of neighboring idea objects within an organization corpus.

19. The system of claim 12, wherein the processor is further configured to perform tag-assisted matching that filters candidate pairs prior to computing embedding-based similarities.

20. The system of claim 12, wherein the one or more processors are further configured to annotate one or more succession edges with semantic deltas indicating constraints added or broadened between versions of an idea object.
